(19) United States
(12) Patent Application Publication
(10) Pub. No.: US 2026/0073286 A1
(43) Pub. Date: Mar. 12, 2026

(54) METHODS AND SYSTEMS FOR MITIGATING BIAS FROM ARTIFICIAL INTELLIGENCE MODELS DURING POST-PROCESSING

(71) Applicant: MASTERCARD INTERNATIONAL INCORPORATED, Purchase, NY (US)

(72) Inventors: Darshika TIWARI, Gurgaon (IN); Maneet SINGH, New Delhi (IN); Harsh SHARMA, New Delhi (IN); Anubha PANDEY, Bikaner (IN); Bhushan Jayant CHAUDHARI, Aurangabad Cantonment (IN)

(73) Assignee: MASTERCARD INTERNATIONAL INCORPORATED, Purchase, NY (US)

(21) Appl. No.: 18/883,726

(22) Filed: Sep. 12, 2024

(51) Int. Cl. G06N 20/00

(52) U.S. Cl. CPC G06N 20/00

(57) ABSTRACT

Methods and systems for mitigating bias from Artificial Intelligence (AI) models during post-processing are disclosed. Method performed by a server system includes accessing first predicted probability score and second predicted probability score for each data sample which is associated with a particular predicted class label having a counterpart class label, a predicted loss category label. Method includes segregating a first set of data samples based on the first predicted probability score and a predefined margin threshold. Method includes segregating a second set of data samples based on the second predicted probability score and a first predefined loss threshold. Method includes segregating a third set of data samples based on the first set of data samples, the second set of data samples, and an overlap condition. Method includes transitioning the predicted class label of each of the third set of data samples to the counterpart class label.

### TECHNICAL FIELD

The present disclosure relates to artificial intelligence-based processing systems and, more particularly, to electronic methods and complex processing systems for mitigating bias from Artificial Intelligence (AI)/Machine Learning (ML) models during post-processing.

### BACKGROUND

In recent times, there has been a widespread adoption of Artificial Intelligence (AI) and/or Machine Learning (ML) models across various real-time applications. However, the development of AI models is accompanied by a concern that these models often produce discriminatory predictions. In other words, most of the models being developed end up generating unfair or biased predictions. Since predictions for these models are often used for decision-making purposes, such biased predictions can lead to severe negative impacts on individuals and society. For example, if a model is trained for loan approval decision-making with a training dataset that is biased towards a particular gender (i.e., a majority group). Then the predictions generated by the trained model may favor the corresponding gender and not the other genders (i.e., a minority group). As a result, individual belonging to the minority group would not be able to experience the benefits of receiving a loan in situations when they might need it the most. Thus, one of the reasons for such behavior of the models may be partly due to bias that already exists in the datasets used for training the models. The bias may be further amplified by the models as, once the models learn the pattern associated with the input datasets, the learning may get stronger every time it is re-trained. Herein, the term ‘bias’ refers to persistent errors or deviations from the actual value that can occur in data or models. It should be noted that the presence of sensitive attributes in the training dataset is the most common reason for the introduction of bias in model predictions.

To mitigate the bias from the models, various techniques have been developed at different stages of the model development, including pre-processing, in-processing, and post-processing techniques. Pre-processing techniques focus on adjusting the training data distribution to balance the sensitive groups. For instance, the training dataset may be carefully pre-processed to remove any traces of sensitive attributes, thereby preventing the models from learning patterns that lead to unfair predictions. In-processing techniques directly incorporate fairness into the model design by altering the existing architecture of the models during the training phase and inducing intrinsically fair models. In-processing techniques are implemented during the training phase of the models. During this phase, in some techniques, model parameters may be optimized such that the model provides fair decisions even with biased input. In some other techniques, latent representations may be fine-tuned to mitigate the bias without huge re-training efforts.

However, such techniques face a glaring drawback, i.e., the need for access to sensitive attributes. As may be understood, the sensitive attributes may either be not available or restricted due to government regulations and privacy issues in some scenarios. Further, there also exists techniques, such as a contrastive learning-based technique, a disentanglement-based technique, etc., that can mitigate bias while reducing the reliance on sensitive attributes. However, most of them are in-processing techniques that require modification in the current sophisticated training architecture of the models which is time-consuming and complex. Further, post-processing techniques calibrate the prediction results after the model training is completed to mitigate the bias. However, these techniques still face the problem of requiring access to sensitive attributes which is undesirable. For instance, in conventional post-processing techniques, if gender is the sensitive attribute, the classification of the data samples in the training dataset in terms of unprivileged group (e.g., female group) and privileged group (e.g., male group) is required to be known by the model in order to change the predictions made by the corresponding model.

Thus, there exists a need for technical solutions, such as improved methods and systems for mitigating bias from AI/ML models during post-processing while overcoming the aforementioned technical drawbacks.

### SUMMARY

Various embodiments of the present disclosure provide methods and systems for mitigating bias from AI/ML models during post-processing.

In an embodiment, a computer-implemented method for mitigating bias from one or more Artificial Intelligence (AI) or Machine Learning (ML) models during post-processing is disclosed. The computer-implemented method performed by a server system includes accessing a first predicted probability score and a second predicted probability score for each data sample of a plurality of data samples from an input dataset stored in a database associated with the server system. Each data sample is associated with a particular predicted class label from at least two predicted class labels and a predicted loss category label from at least two predicted loss category labels. Also, each predicted class label has a counterpart class label. The computer-implemented method may further include segregating a first set of data samples and a second set of data samples from the plurality of data samples based, at least in part, on the first predicted probability score, the second predicted probability score, a predefined margin threshold, and a first predefined loss threshold. Further, the computer-implemented method includes segregating a third set of data samples from the plurality of data samples based, at least in part, on the first set of data samples, the second set of data samples, and an overlap condition. Moreover, the computer-implemented method includes transitioning the predicted class label associated with each of the third set of data samples to the counterpart class label.

In another embodiment, a server system is disclosed. The server system includes a communication interface and a memory including executable instructions. The server system also includes a processor communicably coupled to the memory. The processor is configured to execute the instructions to cause the server system, at least in part, to access a first predicted probability score and a second predicted probability score for each data sample of a plurality of data samples from an input dataset stored in a database associated with the server system. Herein, each data sample is associated with a particular predicted class label from at least two predicted class labels and a predicted loss category label of at least two predicted loss category labels. Also, each predicted class label has a counterpart class label. The server system is further caused to segregate a first set of data samples and a second set of data samples from the plurality of data samples based, at least in part, on the first predicted probability score, the second predicted probability score, a predefined margin threshold, and a first predefined loss threshold. Further, the server system is caused to segregate a third set of data samples from the plurality of data samples based, at least in part, on the first set of data samples, the second set of data samples, and an overlap condition. Moreover, the server system is caused to transition the predicted class label associated with each of the third set of data samples to the counterpart class label.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a first predicted probability score and a second predicted probability score for each data sample of a plurality of data samples from an input dataset stored in a database associated with the server system. Each data sample is associated with a particular predicted class label from at least two predicted class labels and a predicted loss category label from at least two predicted loss category labels. Also, each predicted class label has a counterpart class label. The method may further include segregating a first set of data samples and a second set of data samples from the plurality of data samples based, at least in part, on the first predicted probability score, the second predicted probability score, a predefined margin threshold, and a first predefined loss threshold. Further, the method includes segregating a third set of data samples from the plurality of data samples based, at least in part, on the first set of data samples, the second set of data samples, and an overlap condition. Moreover, the method includes transitioning the predicted class label associated with each of the third set of data samples to the counterpart class label.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a schematic representation of a training pipeline for mitigating bias from one or more Artificial Intelligence (AI) or Machine Learning (ML) models such as a first ML model, in accordance with an embodiment of the present disclosure;

FIG. 4 illustrates a schematic representation of a testing pipeline for mitigating bias from one or more AI or ML models such as the first ML model, in accordance with an embodiment of the present disclosure;

FIG. 5 illustrates a boundary plot of a plurality of data samples in a two-dimensional space depicting a mitigating bias process, in accordance with an embodiment of the present disclosure;

FIG. 6 illustrates a schematic representation of another environment related to at least some example embodiments of the present disclosure;

FIG. 7 illustrates a schematic representation of yet another environment related to at least some example embodiments of the present disclosure; and

FIG. 8 illustrates a flow diagram depicting a method for mitigating bias from AI/ML models during post-processing, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the term “bias” used throughout the description generally refers to persistent errors or deviations from the actual value that can occur in data or Artificial Intelligence (AI) or Machine Learning (ML) models. In addition, biases can be inherent or acquired. Bias in machine learning arises when an algorithm detects and repeats patterns or assumptions that might not hold true in real life or even works to reinforce prejudices in society. This generally occurs when the said AI or ML model is trained using data that is inherently biased or data that includes sensitive attributes.

The terms “bias-mitigation”, “bias reduction”, and “de-biasing” have been interchangeably used throughout the description and generally refer to the prevention and reduction of biases or the negative effects of the biases. Further, it refers to mitigating prejudice in AI or ML models using one or more techniques.

The terms “sensitive attributes” and “protected attributes” have been used interchangeably throughout the description and generally refer to personal attributes or characteristics of an individual. Generally, such attributes are protected by privacy rules or government regulations to prevent discrimination and unfair treatment. In some examples, the sensitive attributes include age, gender, ethnicity, demographics, etc., among other suitable sensitive attributes.

### Overview

Various embodiments of the present disclosure provide methods, systems electronic devices, and computer program products for mitigating bias from Artificial Intelligence (AI)/Machine Learning (ML) models during post-processing. In one embodiment, the present disclosure describes a server system that is configured to access an input dataset from a database associated with the server system. Herein, the input dataset may include information corresponding to a plurality of data samples. Each data sample may correspond to a user. In another embodiment, the server system is configured to generate a plurality of features for each data sample based, at least in part, on the input dataset.

Further, the server system may generate a first predicted probability score for each data sample based, at least in part, on the plurality of features. In a non-limiting implementation, the server system may generate the first predicted probability score using a first ML model associated with the server system. Furthermore, the server system may be configured to assign a particular class of at least two classes to each data sample based, at least in part, on the first predicted probability score for the corresponding data sample.

In another embodiment, the server system may be configured to access the plurality of features for each data sample from the database. Further, the server system may be configured to generate a second predicted probability score for each data sample based, at least in part, on the plurality of features. In a non-limiting implementation, the server system may generate the second predicted probability score using a second ML model associated with the server system. Furthermore, the server system may assign a particular loss category of at least two loss categories to each data sample based, at least in part, on the second predicted probability score for the corresponding data sample. In one embodiment, the server system may store the first predicted probability score and the second predicted probability score in the database which can be used in the future for further processing.

As may be understood, the server system may train the second ML model. Thus, in an embodiment, the server system may be configured to access a plurality of training features and a binary loss label for each training data sample from the database. The server system may further train the second ML model based, at least in part, on iteratively performing a set of operations till convergence criteria are met.

In an embodiment, the set of operations may include: (i) initializing the second ML model based, at least in part, on one or more second model parameters; (ii) generating, by the second ML model, a second predicted probability score for each training data sample based, at least in part, on the plurality of training features and the corresponding binary loss label, the second predicted probability score indicating a likelihood that the training data sample belongs to a particular loss category of the at least two loss categories; (iii) generating, by the second ML model, a second prediction for each training data sample based, at least in part, on the second predicted probability score and the first predefined loss threshold, the second prediction being indicative of the particular loss category; (iv) computing a loss category classification loss for each training data sample based, at least in part, on the second prediction, the corresponding binary loss label, and a loss category classification loss function; and (v) optimizing the one or more second model parameters based, at least in part, on backpropagating the loss category classification loss for each training data sample.

It is to be noted that, in an embodiment, the binary loss label for each data sample may be received from the first ML model. Thus, in an embodiment, the server system may be configured to access a plurality of training features and a plurality of true class labels for each training data sample in a training dataset from the database. Herein, the training dataset may include a non-sensitive training dataset. Further, the server system may be configured to generate a first predicted probability score for each training data sample based, at least in part, on the plurality of training features and the plurality of true class labels. Herein, the first predicted probability score may indicate a likelihood that the training data sample belongs to a particular class of the at least two classes. In a non-limiting example, the server system may generate the first predicted probability score using the first ML model.

Furthermore, the server system may be configured to generate, by the first ML model, a first prediction for each training data sample based, at least in part, on the first predicted probability score and the main class threshold. Herein, the first prediction is indicative of the particular class. Moreover, the server system may be configured to compute a main task loss for each training data sample based, at least in part, on the first prediction, the plurality of true class labels, and a main task loss function using the first ML model. The server system may further be configured to generate a binary loss label for each training data sample based, at least in part, on the main task loss for each training data sample and a second predefined loss threshold using the first ML model. In an embodiment, the binary loss label may include a first state when the main task loss is at least equal to the second predefined loss threshold. In another embodiment, the binary loss label may include a second state when the main task loss is less than the second predefined loss threshold.

Once the training of the second ML model is completed, the server system may generate the second predicted probability score using the second ML model. In a non-limiting implementation, the server system may be configured to access the first predicted probability score and the second predicted probability score for each data sample stored in the database. Further, it is to be noted that, each data sample is associated with a particular predicted class label from at least two predicted class labels and a predicted loss category label from at least two predicted loss category labels. Also, each predicted class label may have a counterpart class label.

Further, in an embodiment, the server system may be configured to segregate a first set of data samples and a second set of data samples from the plurality of data samples based, at least in part, on the first predicted probability score, the second predicted probability score, a predefined margin threshold, and a first predefined loss threshold. In a specific embodiment, the server system may be configured to segregate the first set of data samples from the plurality of data samples based, at least in part, on the first predicted probability score and the predefined margin threshold. In an embodiment, to segregate the first set of data samples, the server system may be configured to access the main class threshold corresponding to a decision boundary initialized for the first ML model, from the database. Further, the server system may be configured to compute a difference between the first predicted probability score for each data sample and the main class threshold. Furthermore, the server system may be configured to determine a confidence value for each data sample based, at least in part, on the difference. Finally, the server system may be configured to extract the first set of data samples from the plurality of data samples that are in proximity to the decision boundary based, at least in part, on the confidence value being less than or equal to a predefined margin threshold. Herein, the first set of data samples may correspond to a set of low-confidence data samples.

In another embodiment, the server system may be configured to segregate the second set of data samples from the plurality of data samples based, at least in part, on the second predicted probability score being at least equal to the first predefined loss threshold. In yet another embodiment, the server system may be configured to segregate a third set of data samples from the plurality of data samples based, at least in part, on the first set of data samples, the second set of data samples, and an overlap condition. In a non-limiting example, to segregate the third set of data samples, the server system may be configured to access the first set of data samples and the second set of data samples from the database. Further, the server system may be configured to extract the third set of data samples from the first set of data samples and the second set of data samples. Herein, each of the third set of data samples may have to meet the overlap condition. The overlap condition may include a condition having the confidence value less than or equal to the predefined margin threshold and the second predicted probability score at least equal to the first predefined loss threshold.

Once the third set of data samples is obtained, the server system may be configured to transition the predicted class label associated with each of the third set of data samples to the counterpart class label. Herein, in an embodiment, the counterpart class label may include a complementary of the predicted class label when a main task corresponds to a binary classification task. In a non-limiting example, to transition the predicted class label to the counterpart class label, the server system may be configured to adjust the decision boundary associated with the first ML model based, at least in part, on the third set of data samples. Further, the server system may be configured to modify a distribution of the plurality of data samples in each of the at least two classes based, at least in part, on the adjustment of the decision boundary.

Further, during the deployment stage, the server system may be configured to receive a prediction request for a payment transaction between a cardholder and a merchant. The server system may be further configured to generate a prediction for the payment transaction based, at least in part, on the first predicted probability score and the main class threshold, the prediction being indicative of a predicted class label. In an embodiment, the server system may generate the prediction using the first ML model. Further, the server system may be configured to de-bias the prediction based, at least in part, on the payment transaction being segregated in the third set of data samples. In an embodiment, the server system may de-bias the prediction using the second ML model. Lastly, the server system may be configured to transmit a de-biased prediction to at least one of an issuer and an acquirer.

Various embodiments of the present disclosure offer multiple advantages and technical effects. For instance, the present disclosure aims to solve the technical problem of how to effectively mitigate bias from AI/ML models. It solves the problem of bias mitigation from the AI or ML models without requiring access to sensitive attributes. As a result, the privacy of the individuals or users whose data is used for training the AI or ML models is protected. Also, the proposed approach requires less processing power, memory, and other resources in comparison to conventional approaches as it is a post-processing technique that merely involves calibrating the prediction results of the model.

For instance, the present disclosure reduces the biases from the model trained to perform a downstream task (such as performing medical diagnosis, fraud detection, and so on) without using labels corresponding to the sensitive attributes. As may be understood, even if sensitive attributes are removed from the input training data, biases may be introduced in the model due to the presence of correlated attributes that imply the sensitive attributes. For example, zip code could be co-related to race, voice tone could be co-related to gender, etc. Thus, to mitigate such biases, the proposed approach identifies boundary samples (i.e., data samples that are classified by the model with low confidence) using the model. The proposed approach further identifies high-loss samples (i.e., data samples that are associated with high-loss values) using a new ML model. Later, the proposed approach identified common data samples that are boundary samples associated with high-loss values. These are the data samples that are most likely wrongly classified by the model due to the presence of biases. Thus, in the proposed approach, labels associated with such data samples are transitioned to their counterparts, thereby mitigating the biases.

More specifically, an application in which a cancer prediction operation, i.e., an operation to predict whether a patient has cancer or not, may be performed. To achieve this, a baseline model can be trained on a historical dataset including information related to several patients. It is noted that due to different demographics, this information may be biased. For instance, older patients generally have a higher likelihood of being diagnosed by cancer than younger patients thus, the information will be biased with more information of older patients with cancer. As a result of this bias, the trained baseline model will also become biased in its predictions towards older patients. This bias will in turn lead to inaccurate predictions. To mitigate such biases, the approach proposed in the present disclosure employs a post-processing approach. Since, the demographic data is considered a sensitive attribute with privacy restrictions, the proposed approach aims to address the bias issue without accessing this sensitive attribute, thus ensuring privacy.

In the proposed approach, the principle of trying to maximize the performance of the worse off group is applied. The principle states that the biased predictions made by the trained baseline model for the patients are in the uncertainty region (i.e., close to a decision boundary). Samples that are placed close to the decision boundary are low confidence samples. For example, if patients P1 and P2 are predicted to suffer from cancer with probabilities 0.6 and 0.4, respectively, which are values close to the decision boundary (i.e., 0.5), then these predictions are less confident predictions. Less confident predictions are more likely to be incorrect predictions. Thus, the proposed approach trains another model to identify high loss samples. For example, if the loss corresponding to the patients P1 and P2 is 0.96 and 0.80, respectively, which are values that are far away from a threshold such as 0.5, then these loss values are high loss values. High loss samples also indicate that the corresponding samples are most likely to be incorrectly classified. The objective of the proposed approach is to identify high loss samples that are close to the decision boundary, and hence an intersection of the boundary samples from the trained baseline model and the high loss samples from the another model is taken. Samples obtained upon intersection correspond to patients that are predicted to suffer from cancer but are most likely to be incorrectly classified (i.e., worse off group samples). Further, by the above-mentioned principle, labels or predictions associated with such samples or patients are inverted. As a result, the performance of the worse off group is enhanced, thereby contributing to the improvement of fairness.

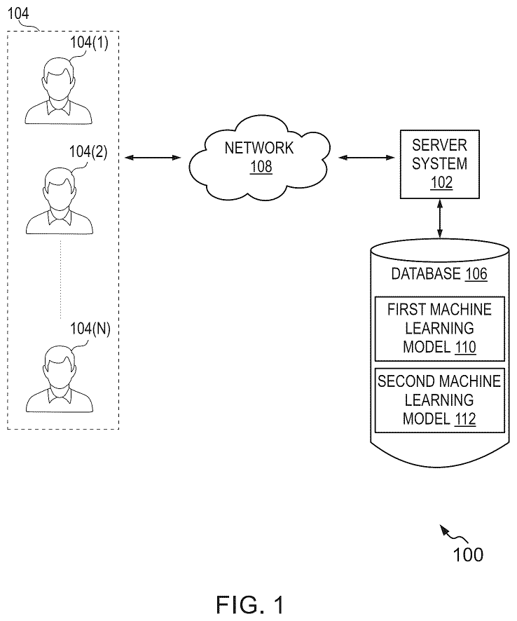

Various example embodiments of the present disclosure are described hereinafter with reference to FIG. 1 to FIG. 8.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, accessing predicted probability scores corresponding to a plurality of data samples, segregating data samples that are both in proximity to a decision boundary and are associated with high loss values, flipping a predicted main class label associated with each of the corresponding data samples with its counterpart main class label, and the like.

The environment 100 generally includes a plurality of entities, such as a server system 102, a plurality of users 104(1), 104(2), . . . 104(N) (collectively referred to hereinafter as a ‘plurality of users 104’ or simply, ‘users 104’), a database 106, each coupled to, and in communication with (and/or with access to) a network 108. Herein, it may be noted that ‘N’ is a non-zero natural number and may be different for each distinct entity.

As may be understood, despite having impressive performance in generating predictions, the Artificial Intelligence (AI) or Machine Learning (ML) models (otherwise, also referred to as ML model(s), model(s), or AI model(s)) are associated with a problem of being biased. The ML models may be biased towards a particular group of people. One of the reasons for the ML models to be biased could be the nature of the models to learn patterns associated with the input data used for training the model based on certain predefined parameters. For instance, the pattern that the model is supposed to learn is the pattern associated with the qualities of candidates who were shortlisted for hiring for a particular job from the input data (historical data), and a particular sensitive attribute of the candidates is revealed to the model. Then, the model along with learning the pattern of the qualities, would also notice the count of hired candidates for each category in the corresponding sensitive attribute. If the input data used for training the model had results in which a larger count of hired candidates belonged to a particular category (i.e., a majority category). Then, the model gives preference to that particular category over the other categories.

Thus, it may be understood that, in some scenarios, the bias can be related to sensitive attributes, making the models biased towards the corresponding sensitive attributes. For instance, bias in AI chatbots, such as employment matching, flight routing, search and advertisement placement platforms, and the like. Other examples include bias in face recognition systems, voice recognition systems, search engines, and the like.

Further, as mentioned earlier, to mitigate the bias from the models, different techniques have been implemented at different development stages of an ML model, such as pre-processing, in-processing, and post-processing techniques. Post-processing techniques are easy to implement and require the least processing power, memory, and other resources in comparison to the three techniques, as they merely involve calibrating the prediction results of the model. However, conventional post-processing techniques require access to the sensitive attributes of the users for mitigating bias. In some situations, such conventional techniques may face potential legal consequences due to the restriction imposed by the Government on access to the sensitive attributes.

Therefore, the above-mentioned technical problems, among other problems, are addressed by one or more embodiments implemented by the server system 102 and the methods thereof provided in the present disclosure. It should be noted that the server system 102 is targeted to implement the post-processing method without the need to have access to the sensitive attributes for mitigating bias from an AI or ML model. It should be noted that the server system 102 performs the debiasing operation without requiring any modification of a model architecture of any of the AI or ML models during a training phase, a testing phase, or a validation phase. Thus, the server system 102 is configured to calibrate the predictions of a main task classifier model such that bias is reduced from the main task classifier model with greater accuracy and preciseness.

In one embodiment, the server system 102 is used by a managing entity to train the AI or ML models and use them for generating predictions related to a downstream task. In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, or the like. In an example, the managing entity may be an administrator of the server system 102.

Examples of the downstream task may include, but are not limited to, speech recognition, image classification, email spam detection, performing medical diagnosis, fraud detection, risk management, charge-back decision-making systems, payment authorization systems, data analytics, credit card scoring systems, cross-border transaction management systems, consumer segmenting, or the like.

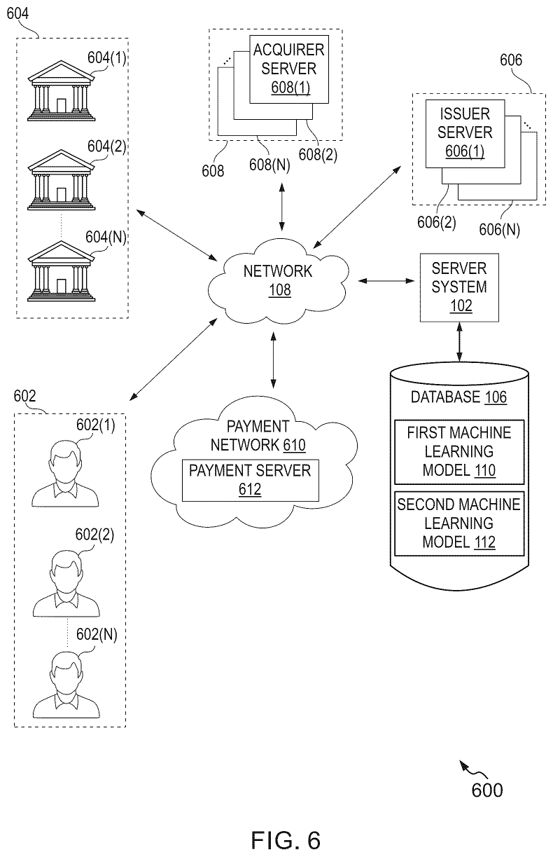

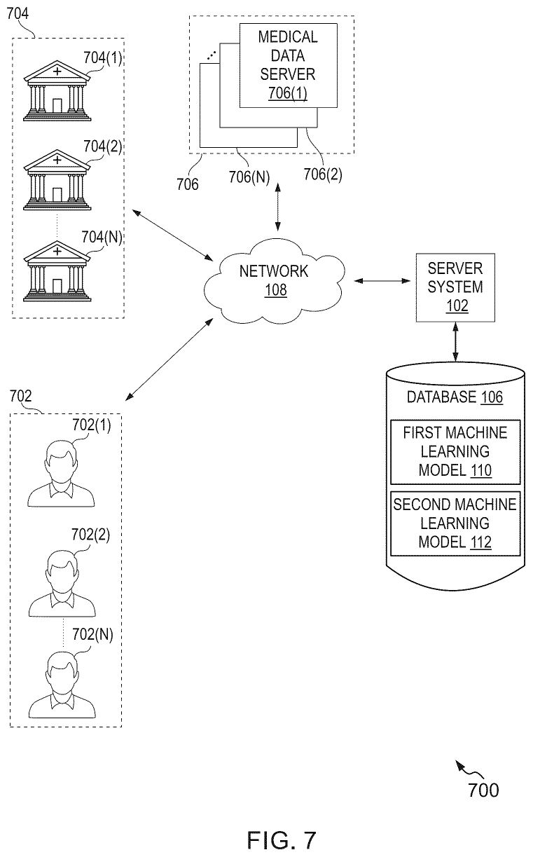

In another embodiment, the users (e.g., users 104) correspond to individuals whose data is used for training the models. For instance, the users 104 may be patients who are undergoing treatment for certain diseases (as shown in FIG. 7). Data generated corresponding to such patients can be used to learn and understand the experience of the patients at a particular clinical center. Thus, such data is used to train AI or ML models to identify diseases and diagnoses. For example, classifying different diseases, such as cancer using images, predicting the progression of pre-diabetes, predicting response to depression treatment, etc. In another instance of a payment industry (as shown in FIG. 6), the users 104 may be cardholders, account holders, merchants, consumers, issuers, acquirers, banks, third-party users, financial institutions, or the like. Data related to such individuals include historical financial transaction-related data, income-related data, expenditure-related data, and the like. Such data can be used to train AI or ML models to predict the income of an individual, predict financial frauds and risks, perform payment authorization operations, and the like.

In some embodiments, the users 104 may use their corresponding electronic devices (not shown in figures) to access a mobile application or a website associated with the issuing bank, or any third-party payment application to perform a payment transaction. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

The network 108 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 108 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 108 may utilize a secure protocol (e.g., Hypertext Transfer Protocol (HTTP), Secure Socket Lock (SSL), and/or any other protocol, or set of protocols for communicating with the various entities depicted in FIG. 1.

In a specific embodiment, the server system 102 may facilitate the managing entity such as an institution involved in reducing bias from one or more AI or ML models that are pre-trained to perform the downstream task. In order to do that, the server system 102 is configured to access a pre-trained model. It is to be noted that the pre-trained model is trained to perform a downstream task (e.g., a binary classification task). Further, its predictions are assumed to be biased towards a particular group corresponding to a particular sensitive attribute (e.g., a privileged group corresponding to gender). In post-processing techniques, to mitigate the bias from the pre-trained model, the predictions of the pre-trained model are modified. The modification may be performed based at least on predefined criteria such that the predictions get de-biased, thereby de-biasing the pre-trained model. In a non-limiting implementation, the predefined criteria correspond to the Rawlsian Max-Min metric. The definition and process of the implementation of these criteria are explained further in the present disclosure.

In brief, in one embodiment, to achieve the predefined criteria, the server system 102 may also access at least one new ML model. Further, the server system 102 may be configured to train the at least one new ML model to perform at least one preferred task. The server system 102 may further be configured to perform a set of operations on predictions obtained from the pre-trained model and the at least one new ML model. It is to be noted that this process is explained in detail further in the present disclosure. In a non-limiting implementation of the present disclosure, the terms a ‘first ML model 110’ for the pre-trained model and a ‘second ML model 112’ for the at least one new ML model are used for the sake of explanation. Thus, in one embodiment, the database 106 may be configured to store one or more AI or ML models such as the first ML model 110 and the second ML model 112.

Further, in an embodiment, the server system 102 may have pre-trained the first ML model 110 for the main task and may train the second ML model 112 for a new task based, at least in part, on a training dataset. In an embodiment, the new task may be such that during testing and/or deployment, the predictions generated by each model can be tweaked to de-bias the first ML model 110. Thus, in one embodiment, the first ML model 110 may generate a first prediction associated with a first predicted probability score when provided with an input dataset. In another embodiment, the second ML model 112 may generate a second prediction associated with a second predicted probability score for the same input i.e., the input dataset. It is to be noted that the process of obtaining the first predicted probability score and the second predicted probability score is explained further in the present disclosure.

In one embodiment, the database 106 is configured to store the input dataset, the first predicted probability score, and the second predicted probability score. In a non-limiting example, the input dataset may include information corresponding to a plurality of data samples. Each data sample may correspond to a user (e.g., the user 104(1)). In such an embodiment, the users 104 are the users whose data is used for training the models, such as the first ML model 110 and the second ML model 112.

Moreover, the first predicted probability score and the second predicted probability score may be generated for each of the plurality of data samples from the input dataset. Herein, the first predicted probability score may indicate a likelihood that the corresponding data sample belongs to a particular class of at least two classes. Similarly, the second predicted probability score may indicate a likelihood that the corresponding data sample belongs to a particular loss category of at least two loss categories.

In one embodiment, the database 106 may be incorporated in the server system 102 or maybe an individual entity connected to the server system 102 or maybe a database stored in cloud storage. In various non-limiting examples, the database 106 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 106. In one implementation, the database 106 may be viewed, accessed, amended, updated, and/or deleted by an administrator (not shown) associated with the server system 102 through a database management system (DBMS) or relational database management system (RDBMS) present within the database 106.

In an embodiment, the server system 102 is further configured to access the first predicted probability score and the second predicted probability score for each of the plurality of data samples from the database 106. In an embodiment, each data sample is associated with a predicted class label from at least two predicted class labels and a predicted loss category label from at least two predicted loss category labels. In another embodiment, each predicted class label has a counterpart class label. The server system 102 may be configured to segregate a first set of data samples and a second set of data samples from the plurality of data samples based, at least in part, on the first predicted probability score, the second predicted probability score, a predefined margin threshold, and a first predefined loss threshold.

The server system 102 may further be configured to segregate a third set of data samples from the plurality of data samples based, at least in part, on the first set of data samples, the second set of data samples, and an overlap condition. Further, the server system 102 may be configured to transition the predicted class label associated with each of the third set of data samples to the counterpart class label. The process of determining the first set of data samples, the second set of data samples, and the third set of data samples, and transitioning the predicted class label of each of the third set of data samples is explained further in the present disclosure.

It is to be noted that, this process may be tested by considering a test dataset and then validated using an input validation dataset. Upon testing and validation, a similar process may be applied to a real-time input dataset. Later, performance and fairness metrics may be computed, and the predefined criteria may be checked. Once the predefined criteria are achieved, the first ML model 110 is considered to be successfully de-biased by the server system 102.

In an embodiment, it may be noted that the methods and systems proposed in the present disclosure can be used in any domain or industry to perform any downstream tasks. The industries may include healthcare, retail, media, travel, crime detection, financial industry, and the like.

It should be understood that the server system 102 is a separate part of the environment 100, and may operate apart from (but still in communication with, for example, via the network 108) any third-party external servers (to access data such as the training datasets to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices are shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 108, which may be specifically configured, via executable instructions, to perform steps as described herein, and/or embodied in at least one non-transitory computer-readable media.

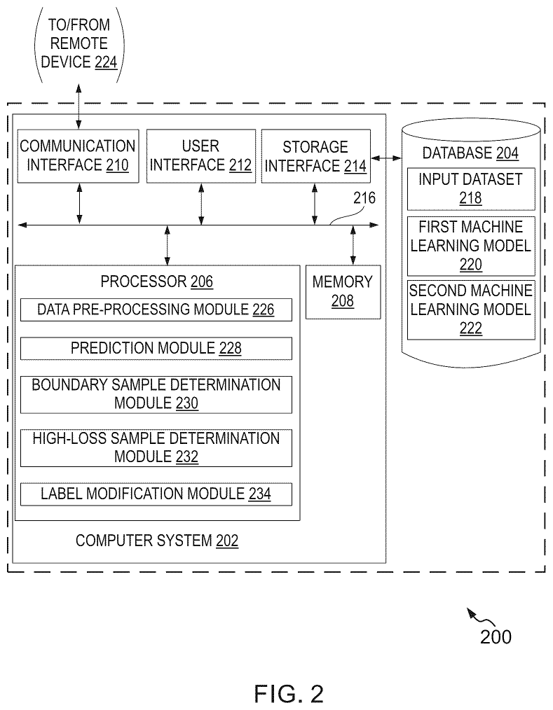

FIG. 2 illustrates a simplified block diagram of a server system 200, in accordance with an embodiment of the present disclosure. The server system 200 is identical to the server system 102 of FIG. 1. In some embodiments, the server system 200 is embodied as a cloud-based and/or SaaS-based (software as a service) architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one embodiment, the database 204 is substantially similar to the database 106 of FIG. 1. In one non-limiting example, the database 204 is configured to store an input dataset 218, a first ML model 220, a second ML model 222, and the like. Herein, the input dataset 218, the first ML model 220, and the second ML model 222 are similar to the input dataset 218, the first ML model 110, and the second ML model 112 described in FIG. 1.

In a non-limiting example, as mentioned earlier in the present disclosure, the input dataset 218 may include the information corresponding to a plurality of data samples. Each data sample may correspond to a user (e.g., the user 104(1)) and associated with a plurality of features. For instance, the adult income dataset may include features, such as work age, gender, income, class, final weight, education, marital status, occupation, relationship, capital gain, capital loss, hours-per-week, native country, class label, and the like. Moreover, in the adult income dataset, each data sample may correspond to each user (e.g., the users 104). In another embodiment, the input dataset 218 may include historical information corresponding to a plurality of activities performed by the users 104 in a predefined domain. Herein, the plurality of activities may include optimized purchases, transactions, consultation, requests for loans, and the like based on the predefined domain of implementation. In some embodiments, the predefined domain may include any domain, field, or industry, such as healthcare, finance, travel, retail, and the like.

Further, the first ML model 220 is pre-trained to generate predictions for a main task such as a classification task, and is assumed to be associated with the bias. The second ML model 222 is trained for reducing the bias from the first ML model 220. Thus, in one embodiment, the database 204 may also be configured to store information related to each of the above-mentioned models 220 and 222. In addition, the database 204 provides a storage location for data and/or metadata obtained from various operations performed by the server system 200.

Further, the computer system 202 may include one or more hard disk drives as the database 204. The user interface 212 is an interface, such as a Human Machine Interface (HMI) or a software application that allows users 104 such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for accessing predicted probability scores corresponding to a plurality of data samples, determining boundary samples, determining high-loss samples, determining overlapping data samples that are both the boundary samples and the high-loss samples, flipping a predicted main class label associated with each of the overlapping data samples with the corresponding counterpart class labels, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 224, such as electronic devices of the users 104, or communicating with any entity connected to the network 108 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 226, a prediction module 228, a boundary sample determination module 230, a high-loss sample determination module 232, and a label modification module 234. It should be noted that components, described herein, such as the data pre-processing module 226, the boundary sample determination module 230, the high-loss sample determination module 232, and the label modification module 234 can be configured in a variety of ways, including electronic circuitries, digital arithmetic, and logic blocks, and memory systems in combination with software, firmware, and embedded technologies. Moreover, it may be noted that the data pre-processing module 226, the boundary sample determination module 230, the high-loss sample determination module 232, and the label modification module 234 may be communicably coupled with each other to exchange information with each other for performing the one or more operations facilitated by the server system 200.

In one embodiment, the data pre-processing module 226 includes suitable logic and/or interfaces for accessing the input dataset 218 from the database 204. In another embodiment, the data pre-processing module 226 may be configured to generate a plurality of features for each data sample based, at least in part, on the input dataset 218. The plurality of features may also be stored in the database 204.

As may be understood, the term ‘dataset’ refers to raw input data that may be used during different stages, such as training, testing, validating, or during deployment of any AI or ML model. However, prior to using the dataset, it is prepared or made suitable for any of the above-mentioned stages by featurization or performing a feature generation operation on the dataset. Generally, the dataset includes multiple data points or data samples. As used herein, the terms ‘data point’ and ‘data sample’, may be used interchangeably, and refer to a single instance or observation within the dataset.

In some embodiments, each data sample may represent a single user or individual. In some other embodiments, based on the nature of the dataset and the problem being addressed, a data sample may represent aggregated or summarized information about multiple users of individuals. However, it is to be noted that each data point or data sample represents a unique combination of features or attributes that describe some aspect of the objective of training the model. During featurization, in one embodiment, these features may be extracted from the dataset for each data sample. In another embodiment, new features may be generated for each data sample using the various data fields associated with each user in the raw data. Both the extracted features and the newly generated features may correspond to insights, useful information, relevant patterns, and the like associated with the dataset.

Thus, it may be understood that the plurality of features may be obtained upon preprocessing the input dataset 218 for improving the model's performance. In a non-limiting example, preprocessing the input dataset 218 may include performing several operations on the input dataset 218 to make the input dataset 218 suitable for any stage of the model. For instance, the operations may include removing noise, feature engineering (also referred to as featurization or feature generation), feature selection, data cleaning, handling missing values, normalizing or scaling data, analyzing characteristics of the data, and converting the input dataset 218 into a format that AI or ML models can process. Since these operations are well known in the art, the same has not been described herein for the sake of brevity.

For instance, as mentioned earlier, the input dataset 218 can correspond to the adult income dataset, which is a publicly available dataset. In an embodiment, the adult income dataset may include a plurality of data samples, each with a plurality of attributes or features as described earlier.

In a scenario where access to the sensitive attributes is prohibited or they are unavailable, training the second ML model 222 may be performed using a training dataset that corresponds to a non-sensitive training dataset. Herein, the non-sensitive training dataset corresponds to a dataset without the sensitive attributes. Thus, in one embodiment, the input dataset 218 can be the non-sensitive training dataset during a training phase of the second ML model 222.

In another embodiment, the first ML model 220 is pre-trained, and may be trained using the training dataset such as the above-mentioned non-sensitive training dataset during its training phase. However, the first ML model 220 is biased due to the presence of correlated attributes that imply the sensitive attributes. For example, zip codes can be correlated attributes to races i.e., even if the race of an individual was not mentioned in the training dataset of a model, but from zip code, there is a possibility to identify a most probable race of the corresponding individual by the model. Thus, based on such attributes, bias may be introduced in the prediction of the first ML model 220.

Further, during a testing phase, the input dataset 218 may correspond to a test dataset, and during a validation phase, the input dataset 218 may correspond to an input validation dataset. Furthermore, during deployment, a real-time input dataset may be used, the de-biasing process explained in the present disclosure may be applied and the performance of the first ML model 220 in generating predictions may be measured. Based on the performance of the first ML model 220 which is now de-biased, it may be confirmed whether it actually got de-biased, and if yes then by what extent may also be determined.

In one embodiment, it is to be noted that the non-sensitive training dataset can be taken from a larger input dataset which is split into a training dataset (i.e., the non-sensitive training dataset), a validation dataset, and a testing dataset. In some other embodiments, the input dataset 218 can be split into a non-sensitive training dataset, a validation dataset, and a testing dataset. During the training phase, the non-sensitive training dataset may be used by the server system 200.

In yet another embodiment, the data pre-processing module 226 may be configured to access the plurality of features for each data sample in the input dataset 218 from the database 204. Upon accessing the plurality of features, in some embodiments, more informative representations may be obtained from the features by generating embeddings. However, the generation of the embeddings is based on the type of data used or specific requirements of the model. In some other embodiments, the features may be directly provided to the model. The plurality of features may be provided to the prediction module 228 for further processing.

In an embodiment, the plurality of features can be a plurality of training features during a training phase of at least one of the first ML model 220 and the second ML model 222. In another embodiment, the plurality of features can be a plurality of test features during the test phase and a plurality of validation features during the validation phase. Further, in an embodiment, during deployment, the plurality of features can be a plurality of real-time features that may be obtained from the real-time input dataset. In some embodiments, the split of the plurality of features for each of the above-mentioned phases may be dependent on the split of the input dataset 218 as explained earlier.

As may be understood, the first ML model 220 is pre-trained. Further, the training process of any AI or ML model is well known to a person skilled in the art, hence it is not explained herein, for the sake of brevity. However, the first ML model 220 is assumed to be associated with the bias. To mitigate this bias without having access to the sensitive attributes, the predefined criteria may be considered and the server system 200 may be targeted to achieve the same. As described earlier, the predefined criteria may include the Rawlsian Max-Min metric. As may be understood, the Rawlsian Max-Min metric aims to increase or maximize the utility of groups in the sensitive attributes where a model accuracy is low. In other words, the metric tries to find a hypothesis ‘h’ such that:

$${h}^{*} = arg {min}_{h ∈ H} {max}_{s ∈ S} {L}_{D s} ( h ) = 0 \qquad Eqn . 1$$

Herein, function ‘L_{Ds} ( )’ corresponds to a loss of each data sample in the input dataset 218, and ‘S’ corresponds to a count of the data samples in the input dataset 218. So, from Eqn. 1 it may be understood that the maximum of the loss values i.e., of all the loss values corresponding to the data samples in the input dataset 218, maximum loss value is considered. This value is minimized by applying the ‘min( )’ function. If the loss generated by the model for a particular data sample is high, then that means the model has not performed well for that particular data sample i.e., model accuracy is low. Further, factors considered for ‘utility’ may be any of model accuracy, precision, Area Under the Precision-Recall Curve (AUC-PR), or the like. Thus, it may be concluded that by minimizing the loss values, the utility can be maximized.

In a non-limiting implementation, to achieve the predefined criteria, the second ML model 222 is introduced in the present disclosure. The second ML model 222 may have to be trained to predict a loss category of each data sample in the input dataset 218. In a non-limiting example, the loss category may include one of a low-loss category and a high-loss category. A threshold loss may be set and data samples having a loss value less than the threshold loss may be categorized in the low-loss category. Similarly, data samples having a loss value greater than the threshold loss may be categorized in the high-loss category. Thus, in one embodiment, the prediction module 228 may be configured to train the second ML model 222.

Thus, it may be understood that both the first ML model 220 and the second ML model 222 are trained to perform a classification task. In a non-limiting example, for performing the classification task, the first ML model 220 and the second ML model 222 can be any of, but not limited to, logistic regression-based models, Support Vector Machine (SVM)-based models, decision tree-based models, random forest-based models, Gradient Boost Machine (GBM)-based models, Neural Network (NN)-based models, and the like.

For training the second ML model 222, the prediction module 228 may be configured to access the plurality of training features and a binary loss label for each training data sample in the training dataset from the database 204. Herein, the binary loss label may indicate a true label for a data sample to be classified under a particular loss category.

In one embodiment, the binary loss label may be received from the first ML model 220. In order to do that, the prediction module 228 may be configured to access the plurality of training features and a plurality of true class labels for each training data sample in the training dataset from the database 204. In an embodiment, the training dataset may include the non-sensitive training dataset. Herein, it is to be noted that the true class labels for the main task may be pre-stored in the database 204 as the first ML model 220 is pre-trained. Moreover, since the current phase is the training phase of the second ML model 222, the features provided for the first ML model 220 are also the training features which are also provided for the second ML model 222.

In another embodiment, the prediction module 228 may be configured to generate a first predicted probability score for each training data sample based, at least in part, on the plurality of training features and the plurality of true class labels. Herein, the first predicted probability score may indicate a likelihood that the training data sample belongs to a particular class of the at least two classes. In a non-limiting implementation, the prediction module 228 may generate the first predicted probability score using the first ML model 220.

As mentioned earlier, the first ML model 220 is pre-trained to perform the main task of predicting a class of each data sample in the input dataset 218. For instance, if the main task is to predict whether a person will default on a loan or not, then the two classes can be ‘will default’ and ‘will not default’. Further, if ‘1’ indicates the ‘will default’ class and ‘0’ indicates the ‘will not default’ class. If the first predicted probability score obtained from the first ML model 220 is 0.8, then it indicates that the likelihood of the selected person belonging to the ‘will default’ class is about 0.8 and the likelihood that the person belongs to the ‘will not default’ class is about 0.2. The conclusion here is that the selected person is more likely to default on the loan as the value is close to ‘1’.

In yet another embodiment, the prediction module 228 may be configured to generate a first prediction for each training data sample based, at least in part, on the first predicted probability score and a main class threshold. Herein, the first prediction may be indicative of the particular class. More specifically, in one embodiment, the prediction module 228 may classify the training data sample in a first class of the at least two classes when the first predicted probability score is at least equal to the main class threshold. In another embodiment, the prediction module 228 may classify the training data sample in a second class of the at least two classes when the first predicted probability score is less than the main class threshold. For instance, the main class threshold is about 0.5. Consider the previous example where the first predicted probability score is 0.8. Then, since 0.8 is greater than 0.5, the corresponding data sample will be classified in the ‘will default’ class.

Further, in yet another embodiment, the prediction module 228 may be configured to compute a main task loss for each training data sample based, at least in part, on the first prediction, the plurality of true class labels, and a main task loss function. As may be understood, in binary classification, true class labels are generally binary values i.e., either ‘0’ or ‘1’. However, predictions generated by any binary classification model have decimal values ranging from ‘0’ to ‘1’. Hence, a loss may be associated with every prediction generated by the model which is also a decimal value ranging from ‘0’ to ‘1’. For instance, for the predicted probability score of 0.8 for a data sample having a true label of ‘1’, the loss can be about 0.32. These loss values may be computed using a loss function. Examples of the loss function can be any of, but not limited to, Mean Squared Error (MSE) loss, binary cross entropy (BCE) loss, Mean Absolute Error (MAE) loss, Root Mean Square Error (RMSE) loss, Kullback-Leibler (KL) divergence loss, or the like. It is to be noted that these loss functions are well known to a person skilled in the art, and hence are not explained in the present disclosure. Thus, in one embodiment, the main task loss function can be any of the above-mentioned loss functions.

As may be understood, the main task loss computed for each training data sample is a decimal value. However, in a non-limiting implementation, the binary loss label that are required for training the second ML model 222 are supposed to be binary values as they are the true labels for the second ML model 222. Thus, the main task loss values may have to be calibrated to generate corresponding binary equivalents. In order to do that, in an embodiment, the prediction module 228 may be configured to generate a binary loss label for each training data sample based, at least in part, on the main task loss for each training data sample and a second predefined loss threshold. More specifically, in one embodiment, the binary loss label includes a first state when the main task loss is at least equal to the second predefined loss threshold. In another embodiment, the binary loss label includes a second state when the main task loss is less than the second predefined loss threshold. In a non-limiting implementation, the first state can correspond to ‘1’ and the second state can correspond to ‘0’ and vice versa depending upon a representation chosen by an administrator of the server system 102. For example, the second predefined loss threshold can be about 0.7. In the example considered earlier, the main task loss was about 0.32. The binary loss label for this value may be ‘0’ as it is less than 0.7. In another instance, when the main task loss for another data sample is 0.73, then the binary loss label generated for that data sample would be ‘1’. Thus, it is to be noted that the plurality of training data samples in the training dataset is associated with the plurality of corresponding binary loss labels.

Referring back to the training process of the second ML model 222, in one embodiment, the prediction module 228 may further be configured to iteratively perform a set of operations until convergence criteria are met. In a non-limiting implementation, the set of operations may include: (i) initializing the second ML model 222 based, at least in part, on one or more second model parameters; (ii) generating, by the second ML model 222, a second predicted probability score for each training data sample based, at least in part, on the plurality of training features and the binary loss label, the second predicted probability score indicating a likelihood that the training data sample belongs to a particular loss category; (iii) generating, by the second ML model 222, a second prediction for each training data sample based, at least in part, on the second predicted probability score and a first predefined loss threshold, the second prediction being indicative of the particular loss category; (iv) computing a loss category classification loss for each training data sample based, at least in part, on the second prediction, the binary loss label, and a loss category classification loss function; and (v) optimizing the one or more second model parameters based, at least in part, on backpropagating the loss category classification loss for each training data sample.

In an embodiment, the one or more second model parameters may be initialized based at least on the type of the model chosen for the second ML model 222. In general, the one or more second model parameters may include, but not be limited to, coefficients or weights associated with each feature, bias terms, regularization parameters, and the like. In another embodiment, the one or more second model parameters may also include hyperparameters, such as leaning rate, epochs, kernel depth for SVM-based models, depth of trees for decision tree-based models, a number of layers, a number of neurons in a hidden layer of NN-based models, batch size, and the like.

Upon initializing the one or more second model parameters, the second ML model 222 may be initialized based on the second model parameters. The prediction module 228 may then generate the second predicted probability score for each training data sample. Then, the second prediction may be generated based at least on the second predicted probability score and the first predefined loss threshold. In a non-limiting implementation, when the at least two loss categories may be a high-loss category and a low-loss category, the first predefined loss threshold can be about 0.7. Data samples having the second predicted probability score at least equal to 0.7 may be categorized in the high-loss category and data samples having the second predicted probability score less than 0.7 may be categorized in the low-loss category.

Further, the prediction module 228 may compute the loss category classification loss for each data sample as the second prediction may not always match with a true label i.e., a binary loss label. However, the loss category classification loss can be reduced by optimizing the one or more second model parameters. Thus, the one or more second model parameters may be optimized by backpropagating the loss category classification loss. These steps may be performed by the prediction module 228 iteratively until the convergence criteria are met. Herein, the convergence criteria may include saturation of the loss category classification loss. In an embodiment, the loss category classification loss may saturate after a plurality of iterations of the set of operations is performed. Herein, saturation may refer to a stage in the model training process after a certain number of iterations where a loss value (e.g., the loss category classification loss) becomes constant, i.e., the difference in the loss value for one iteration and its subsequent iteration becomes the same or negligible. The loss of any model is associated with model performance, so, the less the loss the better the model performance.

Once the convergence criteria are met, the second ML model 222 may be able to generate the second predicted probability score that is highly accurate, thereby generating a highly accurate second prediction about the loss category of the data sample. Further, during the testing phase, the operation of the second ML model 222 may be tested by providing the test dataset. The same test dataset may also be provided to the first ML model 220. Further, a set of operations may be performed on outputs of the first ML model 220 and the second ML model 222 to mitigate bias from the first ML model 220. Thus, in one embodiment, the data pre-processing module 226 may be configured to generate the plurality of test features for each data sample in the test dataset based, at least in part, on the test dataset. Then, the prediction module 228 may be configured to access the plurality of test features and generate a first predicted probability score and a second predicted probability score for each data sample. In one embodiment, the prediction module 228 may generate the first predicted probability score using the first ML model 220 and the second predicted probability score using the second ML model 222. Followed by the generation of the respective predictions and results may be stored in the database 204 which can be accessed in the future for further processing. It is to be noted that, a similar set of operations may be performed for the input dataset 218.

In one embodiment, the boundary sample determination module 230 may be configured to access the first predicted probability score and the second predicted probability score for each of the plurality of data samples from the test dataset or the input dataset 218. As may be understood, the first predicted probability score may indicate a likelihood that the corresponding data sample belongs to a particular class of the at least two classes (related to the main task). Similarly, the second predicted probability score may indicate a likelihood that the corresponding data sample belongs to a particular loss category of the at least two loss categories. Also, it is to be noted that each of the plurality of data samples is associated with a predicted class label and a predicted loss category label. Moreover, each data sample may also have a counterpart class label for the predicted class label. In an embodiment, the counterpart class label may include a complementary of the predicted class label when the main task corresponds to the binary classification task.

In another embodiment, the boundary sample determination module 230 may further be configured to segregate a first set of data samples from the plurality of data samples based, at least in part, on the first predicted probability score and a predefined margin threshold. In order to segregate the first set of data samples, the boundary sample determination module 230 may be configured to access the main class threshold corresponding to a decision boundary initialized for the first ML model 220 associated with the server system 200, from the database 204. Further, the boundary sample determination module 230 may compute a difference between the first predicted probability score for each data sample and the main class threshold.

Furthermore, in an embodiment, the boundary sample determination module 230 may be configured to determine a confidence value for each data sample based, at least in part, on the difference. In another embodiment, the boundary sample determination module 230 may be configured to extract the first set of data samples from the plurality of data samples that are in proximity to the decision boundary based, at least in part, on the confidence value being less than or equal to a predefined margin threshold. In a non-limiting implementation, the first set of data samples corresponds to a set of low-confidence data samples. Moreover, in an embodiment, an absolute of the confidence value may be considered i.e., only positive values of the confidence value may be considered for segregating the first set of data samples.

As may be understood, based on the probability score associated with a data sample, the data sample is placed at a particular distance in a latent space from the decision boundary. As used herein, the term ‘decision boundary’ refers to a threshold that is predetermined, and the data samples are positioned on either side of it during classification. Herein, the main class threshold corresponds to the decision boundary. For instance, if the decision boundary is 0.5, then if a predicted probability score corresponding to a data sample is greater than 0.5, then the data sample is placed above the decision boundary indicating a particular class (e.g., a first class of the at least two classes). Alternatively, if the predicted probability score is less than 0.5, then the data sample is placed below the decision boundary indicating another class (e.g., a second class of the at least two classes). Further, based on the predicted probability score, a distance of the data sample from the decision boundary may be decided. For example, a data sample having a predicted probability score of 0.8 would be positioned farther from the decision boundary having the value of 0.5 in comparison to a data sample having a predicted probability score of 0.6 on one side of the decision boundary. Similarly, a data sample having a predicted probability score of 0.2 would be positioned farther from the decision boundary (0.5) in comparison to a data sample having a predicted probability score of 0.4 on the other side of the decision boundary. Also, it may be noted that the higher the distance of the data sample from the decision boundary, the higher the confidence value and vice versa.

Also, the confidence value indicates the confidence with which the first ML model 220 has classified a data sample into a particular class of the at least two classes. Moreover, it may be understood that there is a possibility that data samples having a lower confidence value are wrongly classified by the first ML model 220. This may be due to the presence of bias in the first ML model 220. Further, it is required to identify data samples that have a high chance of being wrongly classified to mitigate the bias if present.

In a non-limiting implementation, a pair of margins may be set on either side of the decision boundary. The pair of margins may be associated with the predefined margin threshold. For instance, the predefined margin threshold may have a value of about +0.1. If the main class threshold is about 0.5 and the predefined margin threshold is about +0.1, then any predicted probability score between the range of about 0.4 to about 0.6 can be considered to be data samples with the least confidence values and hence can be termed to be boundary samples. As used herein, the term ‘boundary samples’ refers to data samples that are close to the decision boundary and the model has classified them with the least confidence.

More specifically, in one instance, if the first predicted probability score of a particular data sample is 0.45, then the confidence value may be about 0.45-0.5=−0.05. Then, since the absolute of the confidence value i.e., |-0.05| is 0.05 which is less than the predefined margin threshold, the corresponding data sample may be segregated as a part of the first set of data samples from the plurality of data samples that are available in the test dataset or the input dataset 218. Herein, since the first predicted probability score is less than the main class threshold (i.e., 0.5), the data sample belongs to a second class of the at least two classes, e.g., a negative class or class ‘0’. In an example of the main task being to predict whether a person will default on a loan or not, the data sample belongs to the ‘will not default’ class.

In another instance, if the first predicted probability of a particular data sample is 0.6, then the confidence value may be about 0.6−0.5=0.1. Then, since the absolute of the confidence value i.e., 0.1 itself, which is equal to the predefined margin threshold, the corresponding data sample may also be segregated as a part of the first set of data samples from the plurality of data samples that are available in the test dataset or the input dataset 218. Also, the first predicted probability score is greater than the main class threshold (i.e., 0.5), and the data sample belongs to the other class i.e., a first class of the at least two classes, e.g., a positive class or class ‘1’. In an example of the main task to predict whether a person will default on a loan or not, the data sample belongs to the ‘will default’ class.

In yet another instance, if the first predicted probability of a particular data sample is 0.55, then the confidence value may be about 0.55−0.5=0.05. Then, since the absolute of the confidence value i.e., 0.05 itself, which is less than the predefined margin threshold, the corresponding data sample may also be segregated as a part of the first set of data samples from the plurality of data samples that are available in the test dataset or the input dataset 218. Also, the first predicted probability score is greater than the main class threshold (i.e., 0.5), and the data sample belongs to the other class i.e., the first class of the at least two classes, e.g., a positive class or class ‘1’. However, if the first predicted probability score corresponds to either greater than or equal to 0.61, and less than or equal to 0.39, then the data sample may not be segregated in the first set of data samples i.e., they are non-boundary samples.

In one embodiment, the high-loss sample determination module 232 may be configured to segregate a second set of data samples from the plurality of data samples based, at least in part, on the second predicted probability score being at least equal to a first predefined loss threshold. In a non-limiting implementation, the first predefined loss threshold can be about 0.7. Thus, it may be understood that any data sample having the second predicted probability score greater than or equal to 0.7, may be segregated to be a part of the second set of data samples.

Further, as may be understood, the second predicted probability score indicates the likelihood that the corresponding data sample belongs to a particular loss category of at least two loss categories. Also, the at least two loss categories may include one of a high-loss category and a low-loss category. Thus, in one embodiment, when the second predicted probability score of a data sample is at least equal to the first predefined loss threshold, the corresponding data sample may be categorized in a first loss category i.e., the high-loss category. In another embodiment, when the second predicted probability score of the data sample is less than the first predefined loss threshold, the corresponding data sample may be categorized in a second loss category i.e., the low-loss category. The first set of data samples and the second set of data samples may be provided to the label modification module 234 for further processing.

In one embodiment, the label modification module 234 may be configured to segregate a third set of data samples of the plurality of data samples based, at least in part, on the first set of data samples, the second set of data samples, and an overlap condition. In an embodiment, the overlap condition may correspond to a condition according to which data samples that are in both the first set of data samples and the second set of data samples are segregated in the third set of data samples. In other words, the overlap condition may include a condition having the confidence value less than or equal to the predefined margin threshold and the second predicted probability score at least equal to the first predefined loss threshold for the corresponding third set of data samples. In another embodiment, the third set of data samples may include data samples that are close to the decision boundary and also belong to the high-loss category.

In another embodiment, the label modification module 234 may further be configured to transition the predicted class label associated with each of the third set of data samples to the counterpart class label. As may be understood, each of the plurality of data samples is initially assigned with the predicted class label by the first ML model 220. Herein, the predicted class label for each data sample can be either a first class label or a second class label corresponding to the first class or the second class of the at least two classes, respectively. Thus, each of the third set of data samples are also assigned with the predicted class label. Upon obtaining the third set of data samples, transitioning the predicted class label to the counterpart class label may mitigate the bias from the first ML model 220. In other words, if the predicted class label corresponding to a particular data sample in the third set of data samples is the first class label, then the transitioning step may change it to the second class label and vice versa. More specifically, data samples that are close to the decision boundary and categorized in the high-loss category are the ones that are more likely to be wrongly classified by the first ML model 220. The reason for this may be the presence of bias in the first ML model 220. By complementing the predicted class labels assigned, initially, by the first ML model 220 to the data samples, the bias may be mitigated as per the concept of the post-processing method for bias mitigation. Thus, the newly assigned class labels of the data samples (i.e., the third set of data samples) are free from bias.

Later, in an embodiment, the combination of the first ML model 220 and the second ML model 222 and the application of the label modification operation on the third set of data samples may be validated using the validation input dataset. The set of operations performed may be similar to the operations performed during the test phase as explained above in the present disclosure. Further, during deployment, steps similar to that of the test phase may be performed using the real-time input dataset for bias mitigation.

Further, to verify whether the bias was actually mitigated from the first ML model 220, a set of performance metrics and a set of fairness metrics may be measured and compared with that of one or more conventional approaches and/or one or more conventional models. In a non-limiting example, the set of performance metrics may include accuracy, Area Under the Precision-Recall Curve (AUC-PR), F1 score, precision, Recall, and the like. In another non-limiting example, the set of fairness metrics may include a Disparate Impact (DI), an Average odds difference (AOD), a disparate False Positive Rate (FPR), a disparate True Positive Rate (TPR), Statistical Parity Difference (SPD), and the like. It is to be noted that these metrics are well known to a person skilled in the art, and hence are not explained in the present disclosure.

In a non-limiting implementation, an experiment may be conducted on an adult income dataset to verify whether the first ML model 220 is de-biased by the server system 200. As per the experiment, the above-mentioned performance metrics may be measured and the values captured for the proposed approach in comparison to other approaches (i.e., the conventional approaches and the conventional models) are shown in Table 1. Herein, for the sake of the simplicity of the explanation, the first ML model 220 may be labeled as C1. It is noted that the results shown in Table 1 are approximate in nature and may vary by a factor of ±5% due to various experimental conditions.

TABLE 1
Performance metrics for the adult income dataset

| | | | F1 | | |
|---|---|---|---|---|---|
| Performance metrics | AUC-PR | Accuracy | score | Precision | Recall |
| C1 without | 0.763 | 0.870 | 0.714 | 0.789 | 0.650 |
| sensitive attributes | | | | | |
| C1 with | 0.762 | 0.870 | 0.715 | 0.783 | 0.657 |
| sensitive attributes | | | | | |
| A | 0.730 | 0.854 | 0.662 | 0.780 | 0.574 |
| B | 0.728 | 0.854 | 0.657 | 0.784 | 0.565 |
| C | 0.762 | 0.869 | 0.715 | 0.779 | 0.661 |
| Proposed approach | 0.759 | 0.868 | 0.708 | 0.788 | 0.642 |

In another embodiment, the above-mentioned fairness metrics may be measured, and the values captured for the proposed approach in comparison to other approaches (i.e., the conventional approaches and the conventional models) are shown in Table 2. It is noted that the results shown in Table 2 are approximate in nature and may vary by a factor of +5% due to various experimental conditions.

TABLE 2
Fairness metrics for the adult income dataset

| | | | Disparate | Disparate |
|---|---|---|---|---|
| Fairness metrics | DI | AOD | FPR | TPR |
| C1 without sensitive attributes | 0.336 | 0.120 | 0.057 | 0.063 |
| C1 with sensitive attributes | 0.338 | 0.115 | 0.061 | 0.054 |
| A | 0.395 | 0.092 | 0.049 | 0.043 |
| B | 0.000 | 0.749 | 0.083 | 0.666 |
| C | 0.360 | 0.089 | 0.056 | 0.033 |
| Proposed approach | 0.343 | 0.086 | 0.059 | 0.027 |

In an example, the conventional approach ‘A’ can be a Calibrated EO (FNR)-based approach. Similarly, the conventional approach ‘B’ can be a Calibrated EO (FPR)-based approach. Further, the conventional approach ‘C’ can be a priority-based approach. The results in Tables 1 and 2 are also measured for the possibility of just the first ML model 220 with the sensitive attributes and without the sensitive attributes for bias mitigation during post-processing.

Thus, by referring to Tables 1 and 2, it may be observed that not only the performance metrics, but the fairness metrics have also improved in comparison to conventional approaches and conventional models. As a result, a balance between performance and fairness is achieved. It is to be noted that, the experiment may be conducted on any dataset that may be publicly available such as a German-credit dataset.

In another embodiment, an experiment may be conducted to verify whether the Rawlsian Max-Min metric has improved as hypothesized earlier in the present disclosure. In a non-limiting example, experimental results, when the utility considered is AUC-PR are shown in Table 3. It is noted that the results shown in Table 3 are approximate in nature and may vary by a factor of ±5% due to various experimental conditions.

TABLE 3
Results for Adult income dataset

| | | AUC-PR | Accuracy | TPR | FPR |
|---|---|---|---|---|---|
| Baseline | FEMALE | 0.70 | 0.93 | 0.60 | 0.02 |
| classifier | MALE | 0.78 | 0.84 | 0.66 | 0.08 |
| Proposed | FEMALE | 0.73 | 0.94 | 0.61 | 0.02 |
| approach | MALE | 0.77 | 0.83 | 0.65 | 0.08 |

From the results in Table 3, it is understood that, if AUC-PR is considered as the utility for determining the Rawlsian Min-Max metric, then the metric has improved for the worse of groups (i.e., female) in the experiment where the proposed approach is applied on the adult income dataset. It is to be noted that the improvement in the Rawlsian Min-Max metric has been observed in comparison to the conventional model such as a baseline classifier (e.g., the first ML model 220).

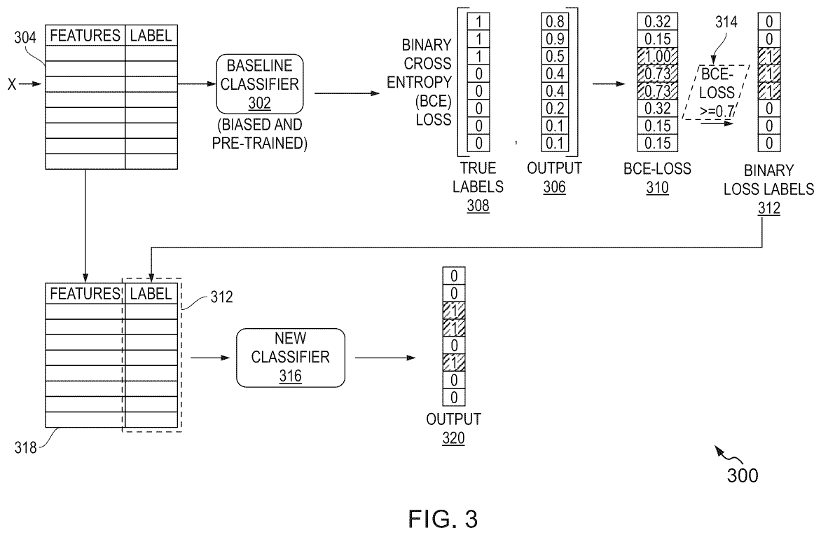

FIG. 3 illustrates a schematic representation 300 of a training pipeline for mitigating bias from one or more AI or ML models such as a first ML model (e.g., the first ML model 220), in accordance with an embodiment of the present disclosure. An example of the first ML model 220 can be a baseline classifier 302 which is a biased and pre-trained model as shown in FIG. 3. As may be understood, the baseline classifier 302 is pre-trained to perform a main task of binary classification of data samples into a first class and a second class of at least two classes. During the training pipeline for bias mitigation, the baseline classifier 302 may be provided with an input 304 including a set of features and corresponding main class labels corresponding to a set of data samples for obtaining an output 306. The data pre-processing module 226 may derive the input 304 from a training dataset including information corresponding to data samples. Each data sample corresponds to a user (e.g., the user 104(1)). The output 306 may include a set of predicted probability scores generated by the baseline classifier 302 for the set of data samples in the input 304, respectively.

Further, a main task loss associated with each of the set of predicted probability scores may be computed using a preferred loss function. In a non-limiting example, the preferred loss function can be a Binary Cross-Entropy (BCE) loss function as the main task is a binary classification task. Suppose the input 304 includes data samples X∈{x₁, x₂, x₃ . . . x_{N}}. Herein, ‘N’ indicates a count of the data samples. A set of predictions that are associated with the set of predicted probability scores generated by the baseline classifier 302 for these data samples may be Ý∈{ŷ₁,ŷ₂,ŷ₃, . . . ŷ_{N}}. Suppose true labels correspond to Y∈{y₁, y₂, y₃ . . . y_{N}}. Then, in a non-limiting implementation, the main task loss may be computed using the following equation of the BCE loss function:

$$Loss ( Y , \hat{Y} ) = - \frac{1}{N} {\sum }_{i = 1}^{N} [ {y}_{i} log ( {\hat{y}}_{i} ) + ( 1 - {y}_{i} ) log ( 1 - {\hat{y}}_{i} ) ] \qquad Eqn . 2$$

As an example, the true labels may have values {1, 1, 1, 0, 0, 0, 0, 0} as shown in FIG. 3 (see, 308). Further, the output 306 having the set of predicted probability scores may have values {0.8, 0.9, 0.5, 0.4, 0.4, 0.2, 0.1, 0.1} as shown in FIG. 3. Upon substituting these values in Eqn. 2, the main task loss i.e., the BCE loss obtained for each data sample may approximately correspond to values shown FIG. 3 (see, BCE-loss 310).

Further, these loss values may be calibrated to binary values for obtaining a set of binary loss label 312 that may be used as true labels (see, label 312) for training the second ML model 222. In a non-limiting implementation, the loss value may be calibrated to ‘1’ when the loss value is greater than or equal to 0.7 and to ‘0’ when the loss value is less than 0.7 (see, 314). Herein, the value 0.7 may be an example of the second predefined loss threshold.

An example for the second ML model 222 can be a new classifier 316 which is supposed to be trained to predict a loss category of each of the data samples in the input 304. However, a new input 318 may be provided to the new classifier 316 which may include the same set of features associated with a new set of labels i.e., the binary loss label 312. As may be understood, the prediction module 228 may train the new classifier 316 for the above-mentioned task, to achieve the predefined criteria such as the Rawlsian Max-Min metric as explained earlier. The steps involved in the training process of the new classifier 316 are similar to those explained earlier for the second ML model 222, and hence not repeated herein for the sake of brevity. Once the new classifier 316 is trained, an output 320 obtained from the new classifier 316 may correspond to the second prediction. Thus, it may be understood that the objective of the training pipeline is to obtain the binary loss label 312, so that the new classifier 316 can be trained to predict the loss category of the data samples. By being able to predict the loss category of any data sample, high-loss samples can be determined. The training pipeline is followed by the testing pipeline for bias mitigation which is explained further in the present disclosure.

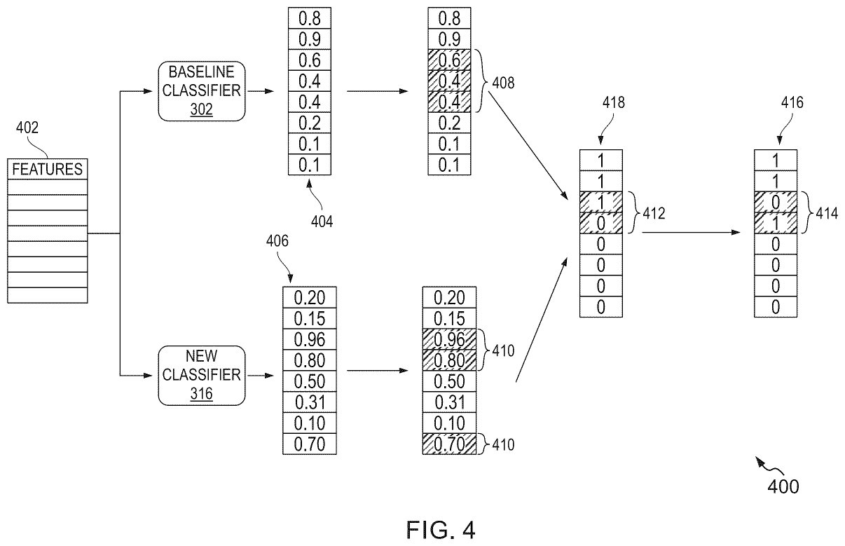

FIG. 4 illustrates a schematic representation 400 of a testing pipeline for mitigating bias from one or more AI or ML models such as a first ML model (e.g., the first ML model 220), in accordance with an embodiment of the present disclosure. Examples of the first ML model 220 and the second ML model 222 are considered in the training pipeline as explained with reference to FIG. 3, the same examples may be considered to illustrate the testing pipeline as well. However, the baseline classifier 302 and the new classifier 316, in the testing pipeline may be provided with a new set of features (i.e., test features) (see, features 402) that may be derived for each data sample from a test dataset by the data pre-processing module 226. A first set of predicted probability scores 404 may be obtained from the baseline classifier 302 as shown in FIG. 4. The first set of predicted probability scores 404 are similar to the first predicted probability score of each data sample explained with reference to FIG. 1 and FIG. 2. Similarly, a second set of predicted probability scores 406 may be obtained from the new classifier 316. These scores are similar to the second predicted probability score of each data sample explained with reference to FIG. 1 and FIG. 2.

Further, the boundary sample determination module 230 may receive the first set of predicted probability scores 404 for determining data samples from the plurality of data samples that are in proximity to the decision boundary. The boundary sample determination module 230 may determine such data samples (otherwise, also referred to as boundary samples) based at least on the first set of predicted probability scores 404, the main class threshold, and the predefined margin threshold. In other words, the boundary sample determination module 230 may choose a data sample that has predicted probability scores close to the decision boundary as shown in FIG. 4 (see, 408). Similarly, the high-loss sample determination module 232 may receive the second set of predicted probability scores 406 for determining data samples with high main task loss. The high-loss sample determination module 232 may determine such data samples based at least on the second set of predicted probability scores 406 and the first predefined loss threshold. In other words, the high-loss sample determination module 232 may choose data samples having the main task loss values greater than or equal to the first predefined loss threshold as shown in FIG. 4 (see, 410).

Furthermore, the chosen samples from the boundary sample determination module 230 and the high-loss sample determination module 232 are provided to the label modification module 234. The label modification module 234 may identify common data samples that are in proximity to the decision boundary as well as have high loss values as shown in FIG. 4 (see, 412). The label modification module 234 may transition the predicted class label associated with the common data samples with the counterpart predicted class label (see, 414). For example, if the predicted class label is ‘0’, then it is transitioned to ‘1’ and vice versa. The resulting output 416 is obtained from the current output 418 of the baseline classifier 302. Herein, the resulting output 416 is considered to be de-biased.

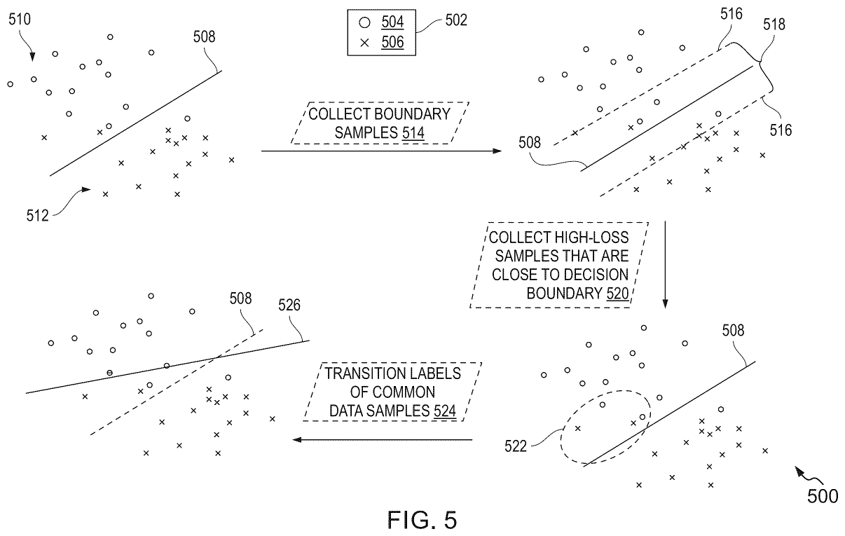

FIG. 5 illustrates a boundary plot 500 of a plurality of data samples (e.g., data samples 502) in a two-dimensional space (2-D space) depicting a bias-mitigation process, in accordance with an embodiment of the present disclosure. Consider the baseline classifier 302 for the first ML model 220 and the new classifier 316 for the second ML model 222. As may be understood, the baseline classifier 302 is pre-trained to perform a binary classification task. Considering that, the data samples 502 may be grouped in two groups, such as a first group 504 (depicted as circle signs) and a second group 506 (depicted as cross signs). Suppose during deployment, the prediction module 228 may generate the first set of predicted probability scores 404 for the data samples 502. Based on the first set of predicted probability scores 404, the data samples 502 may get distributed in the 2-D space on either side of a decision boundary 508. Herein, the decision boundary 508 is similar to the decision boundary explained with reference to FIG. 1 and FIG. 2. Moreover, either side of the decision boundary 508 indicates one of the at least two classes of the binary classification task i.e., a first class 510 and a second class 512.

Ideally, the first group 504 may have to be positioned on the side of the first class 510 and the second group 506 may have to be positioned on the side of the second class 512. However, practically, the baseline classifier 302 may classify some of the data samples 502 of the first group 504 on the side of the second class 512 and vice versa. These inaccuracies may be captured through the main task loss associated with each data sample while the baseline classifier 302 generates the first predictions for the corresponding data samples 502. Further, these inaccuracies may also be due to the presence of bias in the baseline classifier 302. Moreover, the data samples 502 that are close to the decision boundary 508 are assumed to be more prone to error i.e., more likely to be wrongly classified.

As a result, a first step in the bias-mitigation process is to collect boundary samples (see, 514). Thus, in the present disclosure, the boundary sample determination module 230 partitions the 2-D space by a margin 516 depicted as a dotted line in FIG. 5. The portion 518 covered within the margin 516 possesses data samples 502 that can be considered as the boundary samples. As explained earlier, the main class threshold indicates the decision boundary 508, and the predefined margin threshold indicates a permitted range of the first set of predicted probability scores 404 within which if the data samples 502 lie can be segregated as the boundary samples. However, some of these boundary samples may be associated with the main task loss values that are lower than the first predefined loss threshold. Considering that, it may be noted that these may correspond to the data samples 502 that are correctly classified. However, the focus in the present disclosure is to not only collect the boundary samples, but also the data samples 502 that are associated with high loss values.

Thus, in another embodiment, a second step in the bias-mitigation process is to collect high-loss samples that are close to the decision boundary 508 (see, 520). In order to identify the data samples 502 associated with high-loss values, the prediction module 228 may train the new classifier 316 for predicting the high-loss samples from the plurality of data samples. Thus, the new classifier 316 generates the second set of predicted probability scores 406. Further, the high-loss sample determination module 232 may receive the second set of predicted probability scores 406 and segregate the data samples associated with a high loss value based on the first predefined loss threshold. Later, the label modification module 234 may determine the data samples that are close to the decision boundary 508 as well as are high-loss samples by performing an intersection operation between the previously segregated data samples. These common data samples (see, 522) that overlapped with each other are depicted by a dotted circle in FIG. 5.

Further, the third step in the bias-mitigation process is to transition the labels of the common data samples 522 (see, 524). Thus, the label modification module 234 may transition the labels associated with the common data samples to their counterparts. In an embodiment, it may be understood that the transitioning step includes adjusting the decision boundary 508 based at least on the third set of data samples i.e., the common data samples 522. Later, the distribution of the plurality of data samples in each of the at least two classes may be modified based at least on the adjustment of the decision boundary 508. Thus, it may be observed that a new decision boundary 526 may be generated upon the transitioning step. Upon transition, the data samples that were wrongly classified earlier by the baseline classifier 302 may get correctly classified due to the mitigation of the bias from the baseline classifier 302.

FIG. 6 illustrates a schematic representation of another environment 600 related to at least some example embodiments of the present disclosure. Although the environment 600 is presented in one arrangement, other embodiments may include the parts of the environment 600 (or other parts) arranged otherwise depending on, operations performed similar to that performed in the environment 100. Thus, it should be noted that the environment 600 is an example implementation of the environment 100, with the environment 600 representing a financial industry in which the users 104 can be at least one of cardholders and merchants. Thus, the data points of the environment 100 may correspond to payment transactions performed between the cardholders and the merchants in the environment 600.

In one embodiment, the environment 600 includes entities, such as the server system 102, a plurality of cardholders 602(1), 602(2), . . . 602(N) (collectively referred to hereinafter as a ‘plurality of cardholders 602’ or simply ‘cardholders 602’), a plurality of merchants 604(1), 604(2), . . . 604(N) (collectively referred to hereinafter as a ‘plurality of merchants 604’ or simply ‘merchants 604’), a plurality of issuer servers 606(1), 606(2), . . . 606(N) (collectively referred to hereinafter as a ‘plurality of issuer servers 606’ or simply ‘issuer servers 606’), a plurality of acquirer servers 608(1), 608(2), . . . 608(N) (collectively referred to hereinafter as a ‘plurality of acquirer servers 608’ or simply ‘acquirer servers 608’), a payment network 610 including a payment server 612, and the database 106 each coupled to, and in communication with (and/or with access to) the network 108. Herein, it may be noted that ‘N’ is a non-zero natural number that may be different for each entity.

As used herein, the term “cardholder” refers to a person who has a payment account or a payment card (e.g., credit card, debit card, etc.,) associated with the payment account, that will be used by a merchant to perform a payment transaction. The payment account may be opened via an issuing bank or an issuer server (e.g., the issuer server 606(1)). Similarly, as used herein, the term “merchant” refers to a seller, a retailer, a purchase location, an organization, or any other entity that is in the business of selling goods or providing services, and it can refer to either a single business location or a chain of business locations of the same entity. Further, as used herein, the term “payment network” refers to a network or collection of systems used for the transfer of funds through the use of cash substitutes. Payment networks are companies that connect an issuing bank with an acquiring bank to facilitate online payment. Examples of networks or systems configured to perform as payment networks include those operated by such as Mastercard®. In an example, the cardholders 602 may use their corresponding electronic devices to access a mobile application or a website associated with the issuing bank, or any third-party payment application to perform a payment transaction.

As may be understood, one or more AI or ML models that are specifically trained for predicting results for financial domain-related tasks can be biased. For example, in a historical transaction dataset including a historical loan approval dataset can have a greater percentage of males who received loans than their female equivalents. If such a dataset is used to train an AI or ML model, then the predictions that the model might generate on a real-time dataset are most likely to make incorrect predictions and most of the predictions are more likely to be biased toward the majority class. As a result, the server system 102 proposed in the present disclosure may be used to reduce bias from such models. In addition, the server system 102 does not require the presence of sensitive information in the training dataset used for training such models.

In one embodiment, the server system 102 may facilitate payment processors (such as Mastercard®) to mitigate the bias from the one or more AI or ML models such as the first ML model 110 to predict a main task during post-processing. Further, it may be noted that, in a specific example, the server system 102 coupled with the database 106 is embodied within a payment server (e.g., the payment server 612) associated with the payment processor, however, in other examples, the server system 102 can be a standalone component (acting as a hub) connected to the issuer servers 606 and the acquirer servers 608.

In one embodiment, a new ML model may be introduced in the present disclosure such as the second ML model 112 to mitigate the bias from the first ML model 110. In an embodiment, the input dataset 218 used for training the second ML model 112 for performing a task that assists in mitigating the bias from the first ML model 110 is supposed to be free from sensitive attributes and hence is referred to as a non-sensitive training dataset. In a specific implementation, the non-sensitive training dataset may include a cardholder-related dataset excluding sensitive attributes. Along with the cardholder-related dataset, the database 106 may also store a merchant-related dataset and any other historical information that may be related to a plurality of payment transactions performed between the cardholders 602 and the merchants 604 in a payment ecosystem. However, the presence of any of the sensitive attributes may have to be discarded prior to giving such a dataset to the server system 102.

For example, the historical information may include, but is not limited to, transaction attributes, such as transaction amount, source of funds such as bank accounts, debit cards or credit cards, transaction channel used for loading funds such as POS terminal or ATM, transaction velocity features such as count and transaction amount sent in the past ‘x’ number of days to a particular user, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

In other various examples, the database 106 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data.

By accessing the non-sensitive training dataset, the server system 102 is configured to train the second ML model 112 to generate de-biased predictions from the first ML model 110 by performing various operations. It should be noted that the operations explained above with reference to FIG. 1 to FIG. 5 are not described again for the sake of brevity. However, in brief, when a payment transaction is initiated between a cardholder (e.g., the cardholder 602(1)) and a merchant (e.g., the merchant 604(1)), the server system 102 may be configured to receive a prediction request for the corresponding payment transaction between the cardholder 602(1) and the merchant 604(1).

The server system 102 may be further configured to generate a prediction for the payment transaction based, at least in part, on the first predicted probability score and the main class threshold. Herein, the prediction may be indicative of a predicted class label. In an embodiment, the server system 102 may generate the prediction using the first ML model 110. Further, the server system 102 may be configured to de-bias the prediction based, at least in part, on the payment transaction being segregated in the third set of data samples. In an embodiment, the server system 102 may de-bias the prediction using the second ML model 112. Lastly, the server system 102 may be configured to transmit a de-biased prediction to at least one of an issuer associated with an issuer server (e.g., the issuer server 606(1)) and an acquirer associated with an acquirer server (e.g., the acquirer server 608(1)).

In the payment ecosystem, it may be understood that information related to the sensitive attributes related to the cardholders 602 is anyways not accessible to anyone due to security purposes, except for the issuer servers 606 as the cardholders 602 have their payment accounts created with the issuer servers 606 for facilitating online payment transactions. Therefore, the server system 102 in the payment ecosystem may not utilize data from the issuer servers 606 and consider the data that is available with the payment processor.

FIG. 7 illustrates a schematic representation of yet another environment 700 related to at least some example embodiments of the present disclosure. Although the environment 700 is presented in one arrangement, other embodiments may include the parts of the environment 700 (or other parts) arranged otherwise depending on, operations performed similar to that performed in the environment 100. Thus, it should be noted that the environment 700 is an example implementation of the environment 100, with the environment 700 representing a medical industry in which the users 104 can be at least one of the patients and healthcare institutions. Thus, the data points of the environment 100 may correspond to individual patient records corresponding to the patients recorded at the healthcare institutions in the environment 700.

In one embodiment, the environment 700 includes entities, such as the server system 102, a plurality of patients 702(1), 702(2), . . . 702(N) (collectively referred to hereinafter as a ‘plurality of patients 702’ or simply ‘patients 702’), a plurality of healthcare institutions 704(1), 704(2), . . . 704(N) (collectively referred to hereinafter as a ‘plurality of healthcare institutions 704’ or simply ‘healthcare institutions 704’), a plurality of medical data servers 706(1), 706(2), . . . 706(N) (collectively referred to hereinafter as a ‘plurality of medical data servers 706’ or simply ‘medical data servers 706’), and the database 106 each coupled to, and in communication with (and/or with access to) the network 108. Herein, it may be noted that ‘N’ is a non-zero natural number that may be different for each entity.

As used herein, the term “patient” refers to a person who is receiving or registered to receive medical treatment. The patient (e.g., the patient 702(1)) may receive medical treatment from a healthcare professional, such as a doctor, a nurse, a therapist, or the like. The patients 702 may seek medical assistance due to illness, injury, or other concerns about their health. The patients 702 may present with various symptoms, medical conditions, or health-related issues, and they rely on the healthcare professionals to diagnose, treat, and manage their health problems.

Similarly, as used herein, the term “healthcare institution” refers to an institution for medical and surgical treatment and nursing care for sick or injured people i.e., the patients 702. It is to be noted that healthcare institutions 704 provide a wide range of medical services, including emergency care, surgery, diagnostic imaging, laboratory testing, specialized treatments, and the like. Examples of healthcare institutions 704 may include hospitals, clinics, urgent care centers, surgical centers, long-term care centers, rehabilitation centers, mental health facilities, hospices, and the like.

In an example, the healthcare institutions 704 may provide a mobile application or a website for receiving appointments from patients 702. These websites also play a major role in capturing and storing patient-related data in the medical data servers 706 that may be associated with individual healthcare institutions 704. The patients 702 may use their corresponding electronic devices to access the mobile application or the website associated with the healthcare institutions 704 to book appointments with the doctors, take medical advice, request certain medical prescriptions, consult a physician, search for nearby hospitals, learn about various diseases or medical conditions, or the like.

As may be understood, one or more AI or ML models that are specifically trained for predicting results for medical domain-related tasks are biased. For example, in a historical medical dataset of images, a greater number of people in a group of people belonging to a particular race might have suffered from skin cancer than their counterparts. If such a dataset is used to train an AI or ML model, then the predictions that the model might generate on a real-time dataset are most likely to make incorrect predictions and most of the predictions are more likely to be biased toward the majority class. As a result, the server system 102 proposed in the present disclosure may be used to reduce bias from such models. Moreover, the server system 102 also takes care of the privacy of the patients 702 as it does not require access to sensitive attributes of the patients 702 to reduce the bias from such models.

In one embodiment, the server system 102 may facilitate the healthcare institutions 704 to mitigate bias from the one or more AI or ML models such as the first ML model 110 to predict a main task during post-processing. Further, it may be noted that, in a specific example, the server system 102 coupled with the database 106 is embodied within a medical data server (e.g., the medical data server 706(1)), however, in other examples, the server system 102 can be a standalone component (acting as a hub) connected to the medical data servers 706.

In one embodiment, a new ML model may be introduced in the present disclosure such as the second ML model 112 to mitigate the bias from the first ML model 110. In an embodiment, the input dataset 218 may include a patient-related dataset. Along with the patient-related dataset, the database 106 may also store a healthcare institution-related dataset and any other historical information that may be related to individual patient records shared by the patients 702 with the healthcare institutions 704. In an example, the historical information may include, but is not limited to, medical history, symptoms, diagnostic tests, treatments, outcomes, and the like.

In a non-limiting implementation, the patient-related dataset may include patient information, such as name, date of birth, gender, contact information, other demographic details, insurance information, emergency contact information, and the like. In some examples, the patient-related dataset may also include, family medical history, past medical conditions, past surgeries, past procedures, current and past diagnoses, blood tests, imaging scans, prescription medications, allergies and adverse reactions, reports, consultation, and referral history, care plans, and discharge summaries, and the like.

Similarly, the healthcare institution-related dataset may include all the information provided by the patients 702, all the information recorded related to the health conditions of the patients 702, consent forms and patient instructions, billing and administrative data, legal and privacy documents, and the like.

In an embodiment of the present disclosure, the input data used for training the second ML model 112 for performing a task that assists in mitigating the bias from the first ML model 110 is supposed to be free from sensitive attributes. Thus, it may also be referred to as a non-sensitive training dataset. In a specific implementation, the non-sensitive training dataset may include the patient-related dataset excluding sensitive attributes. Along with the patient-related dataset, the non-sensitive training dataset can also include the healthcare institution-related dataset and any other historical information that may be related to the individual medical records of the patients 702 shared and/or recorded at the healthcare institutions 704. However, the presence of any of the sensitive attributes may have to be discarded prior to giving such a dataset to the server system 102.

By accessing the non-sensitive training dataset, the server system 102 is configured to train the second ML model 112 to generate de-biased predictions from the first ML model 110 by performing various operations. It should be noted that the operations are explained above with reference to FIGS. 1, 2, 3, 4, and 5 and not described again for the sake of brevity.

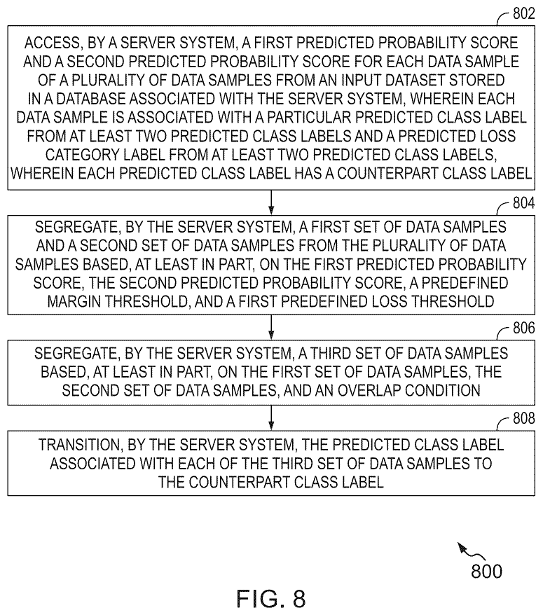

FIG. 8 illustrates a flow diagram depicting a method 800 for mitigating bias from AI/ML models during post-processing, in accordance with an embodiment of the present disclosure. The method 800 depicted in the flow diagram may be executed by, for example, the server system 200. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At operation 802, the method 800 includes accessing, by a server system (e.g., the server system 200), a first predicted probability score and a second predicted probability score for each data sample of a plurality of data samples (e.g., the data samples 502) from an input dataset (e.g., the input dataset 218). Herein, each data sample is associated with a predicted class label from at least two predicted class labels and a predicted loss category label from at least two predicted loss category labels. Also, each predicted class label has a counterpart class label.

At operation 804, the method 800 includes segregating, by the server system 200, a first set of data samples and a second set of data samples from the plurality of data samples 502 based, at least in part, on the first predicted probability score, the second predicted probability score, a predefined margin threshold, and a first predefined loss threshold.

At operation 806, the method 800 includes segregating, by the server system 200, a third set of data samples based, at least in part, on the first set of data samples, the second set of data samples, and an overlap condition.

At operation 808, the method 800 includes transitioning, by the server system 200, the predicted class label associated with each of the third set of data samples to the counterpart class label.

The disclosed method 800 with reference to FIG. 8, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers.

Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein.

In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), BLU-RAY® Disc (BD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a first predicted probability score and a second predicted probability score for each data sample of a plurality of data samples from an input dataset stored in a database associated with the server system,
wherein each data sample is associated with a particular predicted class label from at least two predicted class labels and a predicted loss category label from at least two predicted loss category labels, wherein each predicted class label has a counterpart class label;
segregating, by the server system, a first set of data samples and a second set of data samples from the plurality of data samples based, at least in part, on the first predicted probability score, the second predicted probability score, a predefined margin threshold, and a first predefined loss threshold;
segregating, by the server system, a third set of data samples from the plurality of data samples based, at least in part, on the first set of data samples, the second set of data samples, and an overlap condition; and
transitioning, by the server system, the predicted class label associated with each of the third set of data samples to the counterpart class label.

2. The computer-implemented method as claimed in claim 1, wherein segregating the first set of data samples and the second set of data samples comprises:
segregating the first set of data samples from the plurality of data samples based, at least in part, on the first predicted probability score and the predefined margin threshold; and
segregating the second set of data samples from the plurality of data samples based, at least in part, on the second predicted probability score being at least equal to the first predefined loss threshold.

3. The computer-implemented method as claimed in claim 2, wherein segregating the first set of data samples further comprises:
accessing a main class threshold corresponding to a decision boundary initialized for a first Machine Learning (ML) model associated with the server system, from the database;
computing a difference between the first predicted probability score for each data sample and the main class threshold;
determining a confidence value for each data sample based, at least in part, on the difference; and
extracting the first set of data samples from the plurality of data samples that are in proximity to the decision boundary based, at least in part, on the confidence value being less than or equal to the predefined margin threshold, the first set of data samples correspond to a set of low-confidence data samples.

4. The computer-implemented method as claimed in claim 3, wherein segregating the third set of data samples comprises:
accessing the first set of data samples and the second set of data samples from the database; and
extracting the third set of data samples from the first set of data samples and the second set of data samples, each of the third set of data samples meeting the overlap condition, the overlap condition comprising a condition having the confidence value less than or equal to the predefined margin threshold and the second predicted probability score at least equal to the first predefined loss threshold.

5. The computer-implemented method as claimed in claim 1, wherein transitioning the predicted class label associated with each of the third set of data samples to the counterpart class label comprises:
adjusting a decision boundary associated with a first ML model based, at least in part, on the third set of data samples; and
modifying a distribution of the plurality of data samples in each of the at least two classes based, at least in part, on the adjustment of the decision boundary.

6. The computer-implemented method as claimed in claim 1, wherein the counterpart class label comprises a complementary of the predicted class label when a main task corresponds to a binary classification task.

7. The computer-implemented method as claimed in claim 1, further comprising:
accessing, by the server system, the input dataset from the database, the input dataset comprising information corresponding to the plurality of data samples, each data sample corresponds to a user;
generating, by the server system, a plurality of features for each data sample based, at least in part, on the input dataset;
generating, by a first ML model, the first predicted probability score for each data sample based, at least in part, on the plurality of features; and
assigning, by the server system, a particular class of at least two classes to each data sample based, at least in part, on the first predicted probability score for the corresponding data sample.

8. The computer-implemented method as claimed in claim 7, further comprising:
accessing, by the server system, the plurality of features for each data sample from the database;
generating, by a second ML model associated with the server system, the second predicted probability score for each data sample based, at least in part, on the plurality of features; and
assigning, by the server system, a particular loss category of at least two loss categories to each data sample based, at least in part, on the second predicted probability score for the corresponding data sample.

9. The computer-implemented method as claimed in claim 1, further comprising:
accessing, by the server system, a plurality of training features and a plurality of true class labels for each training data sample in a training dataset from the database, the training dataset comprising a non-sensitive training dataset;
generating, by a first ML model associated with the server system, a first predicted probability score for each training data sample based, at least in part, on the plurality of training features and the plurality of true class labels, the first predicted probability score indicating a likelihood that the training data sample belongs to a particular class of at least two classes;
generating, by the first ML model, a first prediction for each training data sample based, at least in part, on the first predicted probability score and the main class threshold, the first prediction being indicative of the particular class;
computing, by the first ML model, a main task loss for each training data sample based, at least in part, on the first prediction, the plurality of true class labels, and a main task loss function; and
generating, by the first ML model, a binary loss label for each training data sample based, at least in part, on the main task loss for each training data sample and a second predefined loss threshold.

10. The computer-implemented method as claimed in claim 9, wherein the binary loss label comprises:
a first state when the main task loss is at least equal to the second predefined loss threshold; and
a second state when the main task loss is less than the second predefined loss threshold.

11. The computer-implemented method as claimed in claim 9, further comprising:
accessing, by the server system, the plurality of training features and the binary loss label for each training data sample from the database; and
training, by the server system, a second ML model associated with the server system based, at least in part, on iteratively performing a set of operations till convergence criteria are met, the set of operations comprising:
initializing the second ML model based, at least in part, on one or more second model parameters;
generating, by the second ML model, a second predicted probability score for each training data sample based, at least in part, on the plurality of training features and the corresponding binary loss label, the second predicted probability score indicating a likelihood that the training data sample belongs to a particular loss category of at least two loss categories;
generating, by the second ML model, a second prediction for each training data sample based, at least in part, on the second predicted probability score and the first predefined loss threshold, the second prediction being indicative of the particular loss category;
computing a loss category classification loss for each training data sample based, at least in part, on the second prediction, the corresponding binary loss label, and a loss category classification loss function; and
optimizing the one or more second model parameters based, at least in part, on backpropagating the loss category classification loss for each training data sample.

12. The computer-implemented method as claimed in claim 1, further comprising:
receiving, by the server system, a prediction request for a payment transaction between a cardholder and a merchant;
generating, by a first ML model associated with the server system, a prediction for the payment transaction based, at least in part, on the first predicted probability score and the main class threshold, the prediction being indicative of a predicted class label;
de-biasing, by a second model associated with the server system, the prediction based, at least in part, on the payment transaction being segregated in the third set of data samples; and
transmitting, by the server system, a de-biased prediction to at least one of an issuer and an acquirer.

13. A server system, comprising:
a communication interface;
a memory comprising executable instructions; and
a processor communicably coupled to the communication interface and the memory, the processor configured to cause the server system to at least:
access a first predicted probability score and a second predicted probability score for each data sample of a plurality of data samples from an input dataset stored in a database associated with the server system,
wherein each data sample is associated with a particular predicted class label from at least two predicted class labels and a predicted loss category label of at least two predicted loss category labels, wherein each predicted class label has a counterpart class label;
segregate a first set of data samples and a second set of data samples from the plurality of data samples based, at least in part, on the first predicted probability score, the second predicted probability score, a predefined margin threshold, and a first predefined loss threshold;
segregate a third set of data samples from the plurality of data samples based, at least in part, on the first set of data samples, the second set of data samples, and an overlap condition; and
transition the predicted class label associated with each of the third set of data samples to the counterpart class label.

14. The server system as claimed in claim 13, wherein to segregate the first set of data samples and the second set of data samples, the server system is further caused, at least in part, to:
segregate the first set of data samples from the plurality of data samples based, at least in part, on the first predicted probability score and the predefined margin threshold; and
segregate a second set of data samples from the plurality of data samples based, at least in part, on the second predicted probability score being at least equal to a first predefined loss threshold.

15. The server system as claimed in claim 14, wherein to segregate the first set of data samples, the server system is further caused, at least in part, to:
access a main class threshold corresponding to a decision boundary initialized for a first Machine Learning (ML) model associated with the server system, from the database;
compute a difference between the first predicted probability score for each data sample and the main class threshold;
determine a confidence value for each data sample based, at least in part, on the difference; and
extract the first set of data samples from the plurality of data samples that are in proximity to the decision boundary based, at least in part, on the confidence value being less than or equal to the predefined margin threshold, the first set of data samples correspond to a set of low-confidence data samples.

16. The server system as claimed in claim 15, wherein to segregate the third set of data samples, the server system is further caused, at least in part, to:
access the first set of data samples and the second set of data samples from the database; and
extract the third set of data samples from the first set of data samples and the second set of data samples, each of the third set of data samples having the confidence value less than or equal to the predefined margin threshold and the second predicted probability score at least equal to the first predefined loss threshold.

17. The server system as claimed in claim 13, wherein to transition the predicted class label associated with each of the third set of data samples to the counterpart class label, the server system is further caused, at least in part, to:
adjust a decision boundary associated with a first ML model based, at least in part, on the third set of data samples; and
modify a distribution of the plurality of data samples in each of the at least two classes based, at least in part, on the adjustment of the decision boundary.

18. The server system as claimed in claim 13, wherein the server system is further caused, at least in part, to:
access the input dataset from the database, the input dataset comprising information corresponding to the plurality of data samples, each data sample corresponds to a user;
generate a plurality of features for each data sample based, at least in part, on the input dataset;
generate, by a first ML model, the first predicted probability score for each data sample based, at least in part, on the plurality of features; and
assign a particular class of at least two classes to each data sample based, at least in part, on the first predicted probability score for the corresponding data sample.

19. The server system as claimed in claim 18, wherein the server system is further caused, at least in part, to:
access the plurality of features for each data sample from the database;
generate, by a second ML model associated with the server system, the second predicted probability score for each data sample based, at least in part, on the plurality of features; and
assign a particular loss category of at least two loss categories to each data sample based, at least in part, on the second predicted probability score for the corresponding data sample.

20. A non-transitory computer-readable storage medium comprising computer-executable instructions that, when executed by at least a processor of a server system, cause the server system to perform a method comprising:
accessing a first predicted probability score and a second predicted probability score for each data sample of a plurality of data samples from an input dataset stored in a database associated with the server system,
wherein each data sample is associated with a particular predicted class label from at least two predicted class labels and a predicted loss category label of at least two predicted loss category labels, wherein each predicted class label has a counterpart class label;
segregating a first set of data samples and a second set of data samples from the plurality of data samples based, at least in part, on the first predicted probability score, the second predicted probability score, a predefined margin threshold, and a first predefined loss threshold;
segregating a third set of data samples from the plurality of data samples based, at least in part, on the first set of data samples, the second set of data samples, and an overlap condition; and
transitioning the predicted class label associated with each of the third set of data samples to the counterpart class label.
